(19) United States
(12) Patent Application Publication
(10) Pub. No.: US 2015/0198520 A1
(43) Pub. Date: Jul. 16, 2015

(54) SYSTEMS AND METHODS FOR CREATING ALTERED ADHESIVE BONDS

(71) Applicant: The Boeing Company, Seal Beach, CA (US)

(72) Inventors: Allan Joshua SLOCUM, Seattle, WA (US); Megan Nicole WATSON, Kent, WA (US); Joel P. BALDWIN, Seattle, WA (US); Eugene A. DAN-JUMBO, Bothell, WA (US); Michael W. EVENS, Burien, WA (US); Kelly M. GREENE, Kent, WA (US); Russell Lee KELLER, Maple Valley, WA (US); John F. SPALDING, Renton, WA (US)

(73) Assignee: The Boeing Company, Seal Beach, CA (US)

(21) Appl. No.: 14/152,828

(22) Filed: Jan. 10, 2014

(51) Int. Cl. G01N 19/04; B32B 37/18; B32B 15/095; B32B 38/08; B32B 37/00; B32B 37/12; B32B 38/00

(52) U.S. Cl. CPC G01N 19/04; B32B 37/1284; B32B 37/18; B32B 38/0012; B32B 38/08; B32B 37/0038; B32B 15/095; B32B 2038/0016; B32B 2250/03; B32B 2250/40

(57) ABSTRACT

Disclosed are systems and methods of creating altered adhesive bonded joints between metal or composite substrates, including bonds that are weaker in strength than selected reference bonds. One method of creating an altered adhesive bond includes providing a first substrate and a second substrate, selecting a manufacturing process having a plurality of steps designed to produce a desired, or reference, adhesive bond having a desired strength, and selectively altering at least one of the plurality of steps during performance of the manufacturing process to produce an altered bond between the first substrate and the second substrate, the altered bond having an altered strength that is weaker than the strength of the desired adhesive bond. The systems may include systems that may be utilized to create the altered adhesive bonds and/or test standards.

### FIELD

The present disclosure is directed generally to systems and methods for detecting and/or creating defects in materials, and more particularly to methods for detecting and/or creating altered (e.g., weakened) adhesive bonds in metal and/or composite adhesive bonded joints.

### BACKGROUND

Adhesive bonding is used in many applications to create adhesive bonded joints between two substrates (e.g., metallic or composite substrates). Occasionally, manufacturing defects or repair defects can result in surfaces that are in contact with one another but have little actual bonding strength between them. Such bonded joints can pass currently available techniques for non-destructive inspection, but exhibit poor mechanical strength, and are known in the adhesive bonding community as “kissing bonds” or “weak bonds.” Weak bonds are detrimental because they may fail in use, but are generally undetectable by current non-destructive inspection (“NDI”) techniques and their current in-service causes may be unknown.

Strong, durable adhesive bonds are created by proper selection of materials and adhesives, processing, assembly, and curing. Certification of the bond requires, inter alia, that the strength of the bond be validated. Methods are needed to validate that the bond strength measurement techniques are properly calibrated. Validation of bond strength involves a combination of process control validation and final bond quality validation. The development of bond quality validation that returns an estimate of the bond strength requires the use of “test standards,” or specimens, containing controlled levels of bond strength for calibration. The test standards need to be constructed in a repeatable manner so that, as required, additional test standards can be made. Such a series of test standards known to have weak bonds would be useful for developing and evaluating non-destructive methods for detecting the strength of adhesive bonds, to determine whether the method is able to detect a weak bond.

There remains a need for methods of detecting the strength of adhesive bonds, for predicting the creation of a weak adhesive bond, for preventing weak adhesive bonds from occurring, and for creating a test standard having a weakened adhesive bond that can be used for non-destructive testing purposes.

### SUMMARY

Disclosed systems, methods, and apparatus may be used to create an adhesive bond or a plurality of adhesive bonds between a first substrate and a second substrate or a plurality of said substrates, wherein the adhesive bond created by said disclosed systems, methods, and apparatus is altered, such as by being weaker (e.g., has a lower strength) than a reference (e.g., unmodified or unaltered) adhesive bond produced by a selected manufacturing process. Such altered or weakened adhesive bonds can serve as test standards as described herein.

In order to create the altered adhesive bond, one step of a manufacturing process may be altered to produce a weakened bond. Such methods of creating weak bonds and data collected from said weak bonds may in turn be used to create a certification process for bonded rework (e.g., repairs and/or patches on damaged adhesive bonded joints) on aircraft structures, create test standards for certifying non-destructive analysis methods for adhesive bonds, and/or develop new rework state decision logics to prevent in-service occurrence of weak bonds between substrates. Also according to the present disclosure, a test standard manufacturing apparatus may be used to produce one or more test standards having a weakened adhesive bonded joint.

In one method for creating a plurality of altered adhesive bonds between a plurality of first substrates and a plurality of second substrates, a manufacturing process having a plurality of steps can be selected, wherein the manufacturing process can be configured to produce a reference adhesive bond between one of the first substrates and one of the second substrates, the reference adhesive bond having a reference bond strength. During each of a plurality of performances of the manufacturing process, at least one of the steps of the manufacturing process can be selectively altered, thereby producing the plurality of altered adhesive bonds, each of the altered adhesive bonds being formed between one of the first substrates and one of the second substrates. At least a plurality of the altered adhesive bonds may have a strength that is equal to or less than an altered bond strength, wherein the altered bond strength is different from the reference bond strength. Further, the plurality of altered adhesive bonds may be utilized to develop a non-destructive testing method to detect an altered adhesive bond. In some methods, at least one quantitative property of the altered adhesive bond can be compared with the at least one quantitative property of the reference adhesive bond. The first substrates and second substrates may be metallic substrates or composite substrates, and the adhesive bonds may be formed between two of the same type of substrates, and/or between two different substrate types.

Any suitable manufacturing process can be selected. For example, some methods include selecting a selected first substrate from among the plurality of first substrates, selecting a selected second substrate from among the plurality of second substrates, and the manufacturing process can include preparation of a surface of at least one of the selected first substrate and the selected second substrate, abrasion of at least one of the selected first substrate and the selected second substrate, application of an adhesive primer to at least one of the selected first substrate and the selected second substrate, application of an adhesive to at least one of the selected first substrate and the selected second substrate, and application of heat to the selected first substrate and the selected second substrate together in a vacuum to cure the adhesive.

Any of the plurality of steps of the selected manufacturing process may be altered according to methods of the present disclosure. In one specific example, a second material may be substituted for a first material that is recommended by the selected manufacturing process (e.g., the substituted second material may have a lower shear strength and/or a lower peel strength than the recommended first material). For example, a paint primer may be substituted for the adhesive primer recommended by the selected manufacturing process in order to create a weakened, altered adhesive bond between the selected first substrate and the selected second substrate. In other examples, steps of the selected manufacturing process may be altered such as by introducing (or intentionally introducing) a contaminant, sanding improperly (or intentionally sanding improperly), introducing (or intentionally introducing) an improper conversion coating, altering (or intentionally altering) a primer, omitting (or intentionally omitting) a primer, curing inadequately (or intentionally curing inadequately), and using (or intentionally using) an improper adhesive. Introducing a contaminant may include introducing moisture, improperly removing moisture, introducing a hydrophobic contaminant, introducing a hydrocarbon contaminant, inadequately cleaning at least one of the selected first substrate and the selected second substrate, inadequately removing a grease, inadequately removing a mold-release agent, inadequately removing a tape residue, introducing a grease, introducing a mold-release agent, introducing a tape-residue, introducing a paint primer, and/or inadequately removing an existing paint primer.

Altering at least one of the plurality of steps of the selected manufacturing process may include lowering the surface energy of the selected first substrate and/or the selected second substrate, substituting (or intentionally substituting) a substitute primer for a specified primer specified in the selected manufacturing process, mixing (or intentionally mixing) the primer inadequately, applying (or intentionally applying) the primer at a thickness of greater than 25 μm, applying (or intentionally applying) the primer at a thickness of greater than 15 μm, removing an existing paint primer from the first metallic substrate and/or the second metallic substrate and applying a new layer of paint primer to the first metallic substrate and/or the second metallic substrate, and/or preparing the first selected substrate and/or the second selected substrate for bonding and leaving at least some of a pre-existing paint primer on the first metallic substrate and/or the second metallic substrate such that the pre-existing paint primer is present at a time when the adhesive is applied to the first metallic substrate and/or the second metallic substrate.

Method steps described herein may be repeated to create a plurality of altered adhesive bonds between a plurality of respective first substrates and second substrates. Furthermore, data may be measured and/or collected concerning a quantitative property (e.g., a strength) of the altered bonds and stored, for example, in a computer database. Such data concerning the strength of the altered bonds and the methods used to create the same may be analyzed and/or may be used to improve reliability of repairs to bonded joints (e.g., rework). For example, such data may be used to develop a non-destructive testing protocol to detect weak adhesive bonds based on the data (e.g., to determine whether the altered adhesive bond is significantly weaker than the reference adhesive bond having a desired strength), to certify the non-destructive testing protocol, to certify bonded rework on a primary structure of an aircraft, and/or to develop new rework state decision logics to prevent in-service occurrence of weak bonds. The data may be obtained by measuring a quantitative property of the altered bond. The non-destructive testing protocol may include an ultrasonic test, a structural health monitoring test, a pulse-echo test, a thermography test, a shearography test, a laser bond inspection test, and/or a through-transmission ultrasonic test, but such list is non-exclusive and non-limiting.

The present disclosure also concerns embodiments of a test standard and a test standard manufacturing apparatus. Disclosed embodiments of a test standard may include a first metallic substrate, a second metallic substrate, and an altered adhesive bond formed by joining the first metallic substrate and the second metallic substrate. The altered adhesive bond may include a film adhesive, a conversion coating mixture, and a urethane-based primer, and the test standard adhesive bond may be measurably weaker than a desired strength of a reference adhesive bond. In some embodiments, the test standard may include a plurality of first metallic substrates, a plurality of second metallic substrates, and a plurality of altered adhesive bonds between respective first metallic substrates and second metallic substrates.

Other examples of a test standard may include a first composite substrate, a second composite substrate, and an altered adhesive bond formed by joining the first composite substrate and the second composite substrate, wherein the altered adhesive bond has been intentionally produced to include at least one of: at least 0.3% pre-bond moisture, an undercured adhesive, and a hydrocarbon contaminant. In some examples, the altered adhesive bond may be altered with respect to at least one quantitative property relative to a reference adhesive bond.

A test standard manufacturing apparatus may include an abrading apparatus including a plurality of sanding means, a primer application apparatus including an apparatus configured to spray adhesive primer and/or paint primer onto a first substrate and/or a second substrate, a compaction assembly including a vacuum assembly, and a heating apparatus, wherein the heating apparatus may be configured to heat the compaction assembly to a temperature of at least 120° C. The test standard manufacturing apparatus may be configured to produce a test standard, where the test standard includes an altered adhesive bonded joint between the first substrate and the second substrate. At least one of the abrading apparatus, the primer application apparatus, the compaction assembly, and the heating apparatus may be configured to alter a selected step of a manufacturing process in order to produce the altered adhesive bonded joint. The test standard manufacturing apparatus also may include a conversion coating application apparatus including a mixture of first and second conversion coating parts in some examples.

The test standard manufacturing apparatus may be used to create test standards according to the present disclosure. In one example, a test standard may include a first metallic substrate, a second metallic substrate, and a test standard adhesive bond between the first metallic substrate and the second metallic substrate, wherein the test standard adhesive bond includes a film adhesive, a conversion coating mixture, and a urethane-based primer, and wherein the test standard adhesive bond is measurably weaker than a desired strength of a reference adhesive bond. In other examples, a test standard may include a first composite substrate, a second composite substrate, and a test standard adhesive bond between the first composite substrate and the second composite substrate, wherein the test standard adhesive bond includes an adhesive, a paint primer, a mold-release agent, a hydrophobic contaminant, a hydrocarbon contaminant, a grease, a tape residue, and/or a pre-bond moisture presence, and wherein the test standard adhesive bond is measurably weaker than a desired strength of a reference adhesive bond. A plurality of test standard adhesive bonds may be made between a plurality of respective first metallic substrates and respective second metallic substrates, and/or between a plurality of respective first composite substrates and respective second composite substrates.

### BRIEF DESCRIPTION OF THE DRAWINGS

FIG. 1 is an illustrative, non-exclusive example of an aircraft that may include a metal and/or composite adhesive bonded joint.

FIG. 2 is a schematic block diagram of a test standard manufacturing apparatus according to the present disclosure.

FIG. 3 is a partially exploded, schematic representation of a first compaction method that can be used with methods according to the present disclosure and/or with a manufacturing process.

FIG. 4 is a partially exploded, schematic representation of a second compaction method that can be used with methods according to the present disclosure and/or with a manufacturing process.

FIG. 5 is a partially exploded, schematic representation of a cure bagging method that can be used with methods according to the present disclosure and/or with a manufacturing process.

FIG. 6 is a flowchart depicting methods of a prior art manufacturing process for producing a metal adhesive bonded joint.

FIG. 7 is a flowchart depicting methods of a prior art manufacturing process for producing a composite adhesive bonded joint.

FIG. 8 is a flowchart depicting methods according to the present disclosure of creating a weakened adhesive bond.

FIG. 9 is a flowchart depicting methods according to the present disclosure of producing test standards based on data from weakened adhesive bonds produced according to the present disclosure.

### DESCRIPTION

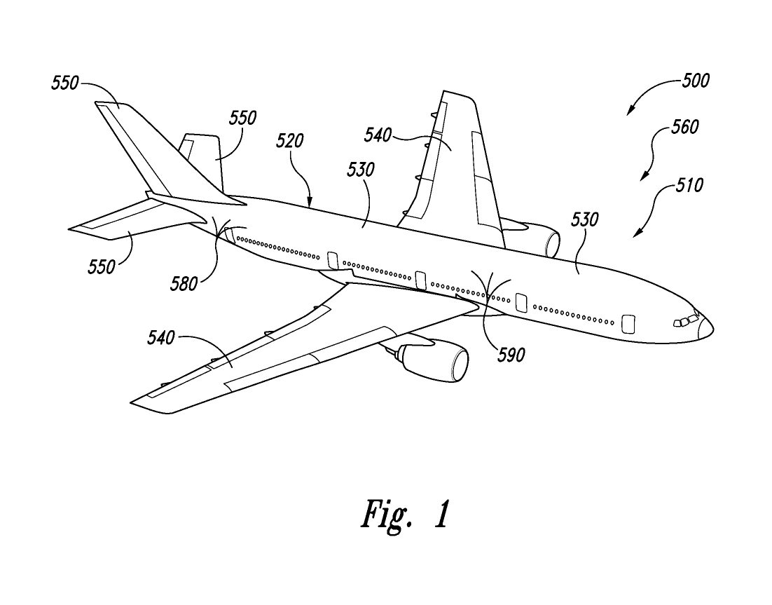

In FIGS. 1-9, illustrative, non-exclusive examples of test standard manufacturing apparatus and/or components thereof, and various methods according to the present disclosure are illustrated. Elements that serve a similar, or at least substantially similar, purpose are labeled with like numbers in each of FIGS. 1-9, and these elements may not be discussed in detail herein with reference to each of FIGS. 1-9. Similarly, all elements may not be labeled in each of FIGS. 1-9, but reference numerals associated therewith may be utilized herein for consistency. Elements, components, and/or features that are discussed herein with reference to one or more of FIGS. 1-9 may be included and/or utilized with any of FIGS. 1-9 without departing from the scope of the present disclosure. Apparatus and methods disclosed herein may be applicable to a wide range of industries, including, but not limited to, aviation, automotive, and wind energy industries.

In general, elements that are likely to be included in a given (i.e., particular) illustrative example are illustrated in solid lines, while elements that are optional to a given example are illustrated in dashed lines. However, elements that are shown in solid lines are not essential to all embodiments, and an element shown in solid lines may be omitted from a particular example without departing from the scope of the present disclosure.

FIG. 1 is an illustrative, non-exclusive example of an aircraft 500 that includes an adhesive bonded joint 560 (e.g., a metal adhesive bonded joint 560 or a composite adhesive bonded joint 560) that may be formed using the systems and methods according to the present disclosure. Aircraft 500 may include a plurality of skin segments 590 that may form and/or be an outer surface of any suitable portion of aircraft 500, and/or that may cover a plurality of frames 580. It is within the scope of the present disclosure that any suitable portion of aircraft 500 may be formed from and/or may include adhesive bonded joint 560. As illustrative, non-exclusive examples, one or more adhesive bonded joints 560 may be present in one or more of an airframe 510, a fuselage 520, a fuselage barrel 530, a wing 540, a stabilizer 550, a skin segment 590, and/or a frame 580 of aircraft 500.

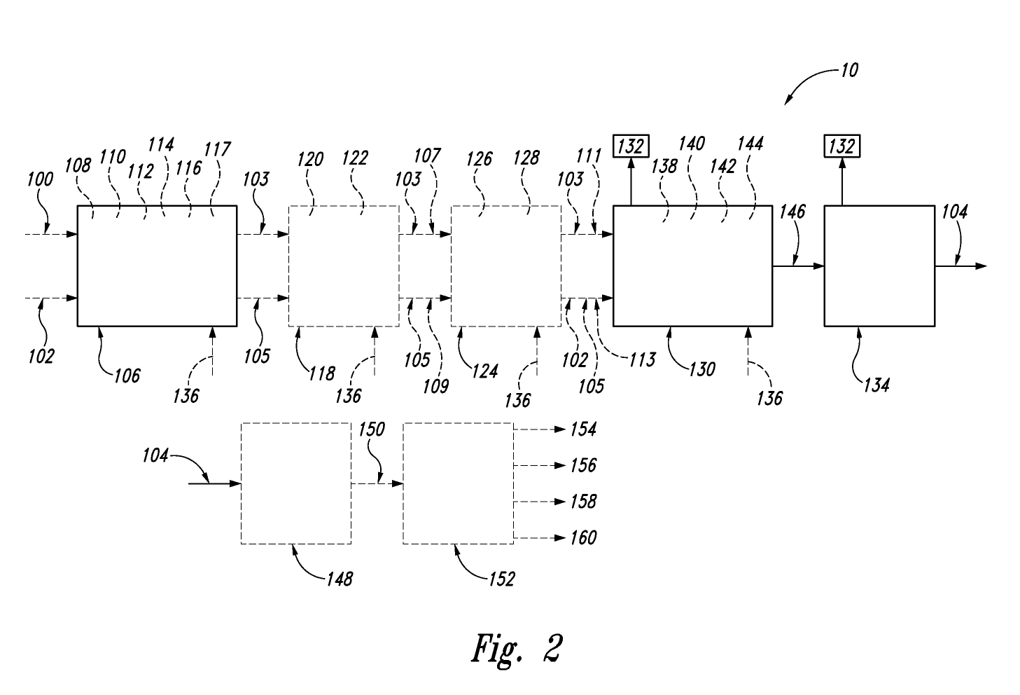

FIG. 2 is a schematic block diagram of a test standard manufacturing apparatus 10 according to the present disclosure. Test standard manufacturing apparatus 10 is configured to operatively attach a first substrate 100 to a second substrate 102 to form an adhesive bonded joint 104 (which can also be referred to as a test standard 104, an adhesive bond 104, an altered adhesive bond 104, or an adhesive joint 104), or a plurality thereof. In some examples, first substrate 100 may be a first metallic substrate, second substrate 102 may be a second metallic substrate, and the resulting adhesive bonded joint 104 may be a metal bonded joint. Alternatively, first substrate 100 may be a first composite substrate, second substrate 102 may be a second composite substrate, and the resulting adhesive bonded joint 104 may be a composite bonded joint. In other examples, a metallic substrate and a composite substrate can be combined to form a hybrid adhesive bonded joint. Resulting adhesive bonded joint 104 may be composed of a first and second substrate, a primer (e.g., an adhesive primer, a paint primer, a urethane-based primer, an epoxy-based primer), an adhesive (e.g., a film adhesive), and/or a conversion coating.

Test standard manufacturing apparatus 10 may include several different processing apparatus, such as an abrading apparatus 106, a conversion coating application apparatus 118, a primer application apparatus 124, a compaction assembly 130, and/or a curing apparatus 134. Test standard manufacturing apparatus 10 may be used to perform an altered version of a selected manufacturing process (also referred to herein as a standard operating procedure), thereby producing an altered adhesive bonded joint 104 having, for example, a lower strength bond (e.g., at least 20% weaker) than a reference adhesive bond that may be produced by performance of the selected manufacturing process as prescribed. In some methods, the strength of the altered adhesive bonded joint 104 may be measured and compared to the reference adhesive bond, such as with a lap shear test and/or a wedge crack propagation test. In a specific example, a measured average crack length of the altered adhesive bonded joint 104 (e.g., a test standard) may be at least 50% greater than an average crack length of the reference adhesive bond.

Abrading apparatus 106 may be used to prepare and/or abrade the surfaces of first substrate 100 and/or second substrate 102, in order to prepare the surfaces for adhesion. First substrate 100 and/or second substrate 102 may be wiped with a solvent, such as acetone, before and/or after abrading (also referred to herein as sanding), to sufficiently clean the bonding surface. At least a portion of first substrate 100 and/or second substrate 102 may be fully abraded so as to remove any existing surface treatments and/or coatings on first substrate 100 and/or second substrate 102. For example, first substrate 100 and/or second substrate 102 may be aluminum substrates having one or more prior surface treatments and/or coatings, such as paint, primer, and/or adhesive. Abrading apparatus 106 may be used to abrade the surface of first substrate 100 and/or second substrate 102 down to bare aluminum (e.g., by removing all the prior surface treatments that may be present on first substrate 100 and/or second substrate 102). Abrading apparatus 106 also may be used to abrade at least a portion of the surface of first substrate 100 and/or second substrate 102 until the surfaces are adequately roughened to facilitate adhesion.

Abrading apparatus 106 may include one or more sanding means 108, 110, 112, 114, 116 (also referred to herein as abrading means 108, 110, 112, 114, 116). For example, sanding means 108 may be a first sheet of sandpaper or a first sanding disc, sanding means 110 may be a second sheet of sandpaper or a second sanding disc, sanding means 112 may be a third sheet of sandpaper or a third sanding disc, sanding means 114 may be a fourth sheet of sandpaper or a fourth sanding disc, and sanding means 116 may be a fifth sheet of sandpaper or a fifth sanding disc. Sanding means 108, 110, 112, 114, and/or 116 may have a grit sufficient to roughen the bonding surface of the first substrate 100 and/or second substrate 102 in order to facilitate or enhance bonding between the substrates. In a specific example, sanding means 108, 110, 112, 114, and/or 116 may be 180 grit, such as 180 grit sandpaper or 180 grit sanding discs. Sanding means 108, 110, 112, 114, and/or 116 may be 150 grit, such as 150 grit sandpaper or 150 grit sanding discs. Sanding means 108, 110, 112, 114, and/or 116 may have a grit between 150 and 180. Sandpaper or sanding discs having a grit different than a recommended grit (e.g., the grit recommended by a selected manufacturing process) may be used in abrading apparatus 106 in some methods where a manufacturing process having a recommended grit is altered. For example, in one illustrative example, abrading apparatus 106 may include one or more sheets of sandpaper having a different grit than that recommended by the selected manufacturing process (e.g., abrading apparatus can include sandpaper having a grit of 120-grit, 100-grit, 80-grit or coarser sandpaper, or sandpaper having 220-grit, 250-grit or finer sandpaper instead of a 150-grit or 180-grit sandpaper recommended by the selected manufacturing process).

Each individual sanding means 108, 110, 112, 114, and/or 116 may be used for a prescribed amount of time and applied in a specific direction on the surfaces of first substrate 100 and/or second substrate 102, to adequately abrade at least a portion the surfaces. For example, first sanding means 108 may be used to abrade at least a portion of the surface of first substrate 100 in a first direction for a minimum of thirty seconds. Second sanding means 110 may then be used to abrade at least a portion of the surface of first substrate 100 in a second direction for a minimum of thirty seconds. The second direction may be different from the first direction. For example, the second direction may be rotated about ninety degrees from the first direction. Then, third sanding means 112 may be used to abrade at least a portion of the surface of first substrate 100 for a minimum of thirty seconds in a third direction (e.g., rotated another ninety degrees from the second direction, or 180 degrees rotated from the first direction). Fourth sanding means 114 may be used to abrade at least a portion of the surface of first substrate 100 in a fourth direction for a minimum of thirty seconds, where the fourth direction may be rotated about ninety degrees from the third direction, or about 270 degrees rotated from the first direction. Fifth sanding means 116 may be used to abrade at least a portion of the surface of first substrate 100 in any or all directions for a minimum of thirty seconds to generate an abraded first substrate 103.

A polishing material 117 (e.g., a non-woven ceramic abrasive such as a non-woven ceramic grain disc or sheet, ceramic grain, or an aluminum oxide mineral such as Scotch-Brite®) may be used to polish the surface of first substrate 100 and/or second substrate 102. Any resulting dust from abrading and/or polishing may be removed with, for example, compressed air. Thusly abraded first substrate 103 then may be further processed. At least a portion of the surface of second substrate 102 likewise may be abraded to form an abraded second substrate 105, which in turn may be further processed as well.

Conversion coating application apparatus 118 may be used to apply a conversion coating, such as an anodized conversion coating, a silane conversion coating, an etching chemical, and/or sol-gel. In some examples, the conversion coating may have one or more parts mixed together, such as a sol-gel coating having a first sol-gel part 120 and/or a second sol-gel part 122, to abraded first substrate 103 and/or to abraded second substrate 105 to form a coated first substrate 107 and/or a coated second substrate 109. Typically, conversion coatings such as sol-gel are applied as a mixture of parts, such as a mixture of first sol-gel part 120 and second sol-gel part 122. In one example, first sol-gel part 120 and second sol-gel part 122 may be mixed (e.g., by shaking first and second sol-gel parts 120, 122 for at least 15 seconds) prior to abrading first substrate 100 and/or second substrate 102 with abrading apparatus 106. In this manner, the sol-gel mixture may be ready for application once the abrading is complete. Conversion coating application apparatus 118 may be used to apply the conversion coating to abraded first substrate 103 and/or to abraded second substrate 105 within a maximum threshold coating time after an event (e.g., abrading the surfaces or mixing the conversion coating parts) or after a minimum threshold coating time after an event. The maximum or minimum threshold coating time may vary in different methods. The threshold coating time may be a maximum of 15 minutes, a minimum of 15 minutes, a maximum of 30 minutes, a minimum of 30 minutes, a maximum of 60 minutes, a minimum of 60 minutes, a maximum of 90 minutes, a minimum of 90 minutes, a maximum of 120 minutes, a minimum of 120 minutes, a maximum of 150 minutes, a minimum of 150 minutes, a maximum of 180 minutes, a minimum of 180 minutes, a maximum of 240 minutes, a minimum of 240 minutes, a maximum of 300 minutes, a minimum of 300 minutes, a maximum of 24 hours, and/or a minimum of 24 hours. For example, the conversion coating may be applied within a maximum threshold coating time after completion of the abrading (e.g., no more 30 minutes after abrading the surfaces, or no more than 60 minutes after abrading the surfaces). In other examples, the conversion coating may be applied after a minimum threshold coating time after completion of the abrading (e.g., at least 4 hours after abrading the surfaces, or at least 24 hours after abrading the surfaces). Additionally or alternatively, the conversion coating may be applied within a maximum threshold coating time after mixing the conversion coating or may be applied after a minimum threshold coating time after mixing the conversion coating parts (e.g., at least 30 minutes after mixing the conversion coating parts, or no more than 30 minutes after mixing the conversion coating parts).

Conversion coating application apparatus 118 may be, for example, a brush used to apply the conversion coating. The conversion coating can consist of a first conversion coating part 120 and/or a second conversion coating part 122 (e.g., a mixture of first sol-gel part 120 and second sol-gel part 122, first sol-gel part 120, or second sol-gel part 122) and can be applied to at least a portion of abraded first substrate 103 and/or abraded second substrate 105 substantially continuously for a threshold conversion coating application time. The threshold conversion coating application time may be at least 30 seconds, at least a minute, at least 2 minutes, or greater than 2 minutes. Conversion coating application apparatus 118 also may provide for the draining of excess conversion coating solution off the coated parts (e.g., coated first substrate 107 and/or coated second substrate 109) for a threshold conversion coating draining time. The threshold conversion coating draining time may be at least 2 minutes, at least 5 minutes, at least 10 minutes, and/or greater than 10 minutes. In some methods, a wipe that has been pre-wetted with the conversion coating mixture may be used to blot excess solution off the coated parts. Coated first substrate 107 and/or coated second substrate 109 may be allowed to dry for a threshold conversion coating drying time. The threshold conversion coating drying time may be at least 30 minutes, at least 60 minutes, at least 90 minutes, at least 120 minutes, at least 24 hours, or greater than 24 hours. In some examples, the threshold conversion coating drying time may be between 30 minutes and 48 hours.

Primer application apparatus 124 may be used to apply a primer, such as an adhesive primer 126 and/or a paint primer 128 to at least a portion of coated first substrate 107, coated second substrate 109, abraded first substrate 103, and/or abraded second substrate 105, in order to form a primed first substrate 111 and/or a primed second substrate 113. In one specific example, a corrosion-inhibiting adhesive primer may be applied by primer application apparatus 124. Primer application apparatus 124 may be configured to agitate and/or shake the primer during application of the primer. The primer may be removed from refrigeration prior to its application and allowed to reach a certain temperature before opening the container. For example, the primer may be allowed to reach at least 50° F., at least 55° F., at least 60° F., at least 65° F., at least 70° F., at least 75° F., at least 80° F., at least 85° F., at least 90° F., at least 95° F., and/or at least 100° F. before opening the container (e.g., at least 10° C., at least 12° C., at least 15° C., at least 18° C., at least 21° C., at least 24° C., at least 26° C., at least 29° C., at least 32° C., at least 35° C., and/or at least 37° C.).

The primer may be mixed and transferred to a reservoir, such as a reservoir of primer application apparatus 124, which may be, for example, a spray gun functional for spray application of the primer. In some examples, the primer may be applied to at least a portion of coated first substrate 107 and/or coated second substrate 109 after the threshold conversion coating drying time. In other examples, such as those where conversion coating is not applied, the primer may be applied to at least a portion of abraded first substrate 103 and/or abraded second substrate 105 after the surfaces have been abraded and cleaned.

The primer may be applied to a thickness of at least 0.00010″, at least 0.00015″, at least 0.00020″, at least 0.00030″, at least 0.00040″, at least 0.00050″, at least 0.00060″, at least 0.00070″, at least 0.00080″, at least 0.00090″, at least 0.0010″, and/or greater than 0.0010″ (at least 2.5 μm, at least 3.8 μm, at least 5.1 μm, at least 7.6 μm, at least 10.2 μm, at least 12.7 μm, at least 15.2 μm, at least 17.8 μm, at least 20.3 μm, at least 22.9 μm, at least 25.4 μm, and/or greater than 25.4 μm). In some methods, the thickness of the primer may be measured to verify the thickness, such as by an eddy current procedure or using a visual standard or other procedure. The primer may be at least partially cured before being laid up with adhesive (e.g., before an adhesive is applied to one or more of the substrates), such as by curing for at least 15 minutes, at least 30 minutes, at least 60 minutes, or greater than 60 minutes, at a temperature of at least 100° F., at least 110° F., at least 120° F., at least 130° F., at least 140° F., at least 150° F., and/or greater than 150° F. (at least 37° C., at least 43° C., at least 48° C., at least 54° C., at least 60° C., at least 65° C., and/or greater than 65° C.).

An adhesive 144 may be applied to one or more of the substrates in association with compaction assembly 130. For example, adhesive 144 may be applied to primed first substrate 111 and/or primed second substrate 113. Alternatively, adhesive 144 may be applied to abraded first substrate 103, abraded second substrate 105, and/or second substrate 102 (such as in cases where test standard manufacturing apparatus 10 does not include optional conversion coating application apparatus 118 and/or optional primer application apparatus 124, and thus the abraded and/or unprocessed substrates may be used in compaction assembly 130). A vacuum assembly 132 may apply a vacuum to compaction assembly 130 to enhance bonding.

Adhesive 144 may be a film adhesive such as a moisture-resistant, toughened, modified epoxy film. Specific examples of suitable adhesives include film adhesives, paste, multi-part paste, epoxies, acrylics, polyurethanes, and polyimides. Once adhesive 144 is applied to primed first substrate 111, primed second substrate 113, abraded first substrate 103, abraded second substrate 105, and/or to second substrate 102, then two of said substrates may be operatively located in contact with one another within compaction assembly 130. For example, one of primed first substrate 111 and abraded first substrate 103 may be operatively located in contact with one of primed second substrate 113, abraded second substrate 105, and second substrate 102. In one specific example, primed first substrate 111 may be positioned adjacent primed second substrate 113 with adhesive 144 positioned between primed first substrate 111 and primed second substrate 113 in order to form an uncured adhesive bonded joint 146. Similarly, primed first substrate 111 may be positioned adjacent second substrate 102 with adhesive 144 positioned between primed first substrate 111 and second substrate 102 in order to form uncured adhesive bonded joint 146. In other examples, abraded first substrate 103 may be positioned adjacent either abraded second substrate 105 or second substrate 102 with adhesive 144 positioned there between to form uncured adhesive bonded joint 146.

Adhesive 144 may be an adhesive recommended by a selected manufacturing process. Additionally or alternatively, compaction assembly 130 may be used to apply an incorrect adhesive 138 (e.g., an adhesive other than that recommended by the selected manufacturing process), an improperly stored adhesive 140 (e.g., stored at a temperature that is too high or too low to maintain integrity of the adhesive), and/or an out-of-date adhesive 142 (e.g., an adhesive used past its shelf-life).

In some examples, first substrate 100, coated first substrate 107, primed first substrate 111 and/or abraded first substrate 103 may be a repair surface (e.g., a surface from an aircraft in need of repair) with adhesive applied thereon. Second substrate 102, primed second substrate 113, coated second substrate 109, and/or abraded second substrate 105 may be a repair patch that may be positioned on the adhesive applied on the surface of the primed first substrate 111 or the adhesive applied on the surface of the abraded first substrate 103. The adhesive may be applied within four hours of surface preparation (e.g., within four hours of abrading and/or cleaning the surface of the primed first substrate 111 and/or abraded first substrate 103). Alternatively, the adhesive may be applied more than four hours after abrading and/or cleaning the surface, thereby intentionally allowing oxidation and creating poor bonding conditions.

Curing apparatus 134 may be used to cure the primer and/or adhesive as applied to uncured adhesive bonded joint 146. A selected manufacturing process may specify recommended ramp rates, cure temperatures, and/or cure times for curing. Curing apparatus 134 and/or a vacuum assembly 132 may be used to perform a cure cycle as recited in a selected manufacturing process. Alternatively, curing apparatus 134 and/or vacuum assembly 132 may perform a method that is an altered version of a selected manufacturing process. For example, curing apparatus 134 and/or vacuum assembly 132 may be used to intentionally overcure or intentionally undercure an adhesive and/or a primer.

In some methods, vacuum assembly 132 may apply a vacuum while curing apparatus 134 heats uncured adhesive bonded joint 146. Curing apparatus 134 may be a heating apparatus configured to apply a cure temperature of between 240° F. and 260° F. (between 115° C. and 127° C.) for at least ninety minutes. Curing apparatus 134 may ramp up the temperature applied at a controlled rate, such that, for example, the temperature increases at a rate of about 5° F. per minute (about 2.8° C. per minute) as the temperature is increased from room temperature to the cure temperature. Once curing is performed for a selected curing time, adhesive bonded joint 104 may be complete. In some examples, curing apparatus 134 may be an oven, a kiln, a heat blanket, and/or any other device or apparatus functional to apply the desired heat and/or cure the uncured adhesive bonded joint 146. Additionally or alternatively, curing apparatus 134 may apply ultraviolet light and/or moisture to cure the uncured adhesive bonded joint 146. Vacuum assembly 132 may include a means for applying a vacuum and a vacuum bag applied on or around the uncured adhesive bonded joint 146 that may be configured to apply a desired level of vacuum to the uncured adhesive bonded joint 146 to compact the joint and/or to enhance bonding during the cure. For example, vacuum assembly 132 may apply a vacuum of at least 10 in Hg, at least 12 in Hg, at least 14 in Hg, at least 16 in Hg, at least 18 in Hg, and/or at least 20 in Hg (at least 254 mm Hg, at least 304 mm Hg, at least 355 mm Hg, at least 406 mm Hg, at least 457 mm Hg, and/or at least 508 mm Hg).

As illustrated in dashed lines in FIG. 2, test standard manufacturing apparatus 10 may include a test 148 that may test the strength of adhesive bonded joint 104 and generate data 150 regarding said strength and/or other aspects of the adhesive bonded joint 104. For example, after curing, the adhesive bonded joint 104 may be removed from the vacuum bag and/or curing apparatus and subjected to inspection, such as by a non-destructive test.

Test standard manufacturing apparatus 10 may be used to produce a plurality of adhesive bonded joints 104 to serve as test standards, where the adhesive bonded joints 104 are intentionally altered or weakened by, for example, the introduction of a contaminant within the adhesive bonded joints 104, and/or by some alteration of one or more steps of the selected manufacturing process. For example, test standard manufacturing apparatus 10 may be used to fabricate a test standard having a weak bond that imitates a weak bond in a structural panel of an aircraft. In one example, test standard manufacturing apparatus 10 may be used to make a plurality of adhesive bonded joints 104, where different levels of contamination are introduced (e.g., different amounts of one or more contaminants were introduced) within the test standard manufacturing apparatus 10. The test 148 may then be performed on each of the plurality of adhesive bonded joints 104, and a relationship between the strength of the adhesive bonded joint 104 and the contamination level may be determined, based on resulting data 150. Test 148 may include one or more destructive tests and/or one or more non-destructive tests. For example, test 148 may include one or more of a peel test, a climbing drum peel test, a wedge test, a lap shear test, a paint conversion test, a crack propagation test, an ultrasonic test, a structural health monitoring test, a pulse-echo test, a thermography test, a shearography test, a laser bond inspection test, and a through-transmission ultrasonic test.

Data 150 may be input into a database 152. Database 152 may in turn use and/or analyze said data 150 to create, for example, quality control checks 154, a certification process for bonded rework 156, standards to certify non-destructive evaluation tools 158, and/or rework state decision logic 160 that may be used to prevent in-service creation of weak adhesive bonded joints. For example, data 150 may be used to create methods to control the strength or weakness of a produced adhesive bonded joint, so that adhesive bonded joints having a reliably weak strength may be produced. These weak adhesive bonded joints may be used to, for example, verify new methods of non-destructive bonded structure testing. Ultimately, non-destructive tests may be developed, based on said data 150, to measure the strength of bonded structures, detect weak bonds, and/or prove strong bonds.

As also illustrated in dashed lines in FIG. 2, a contaminant 136 may be introduced into various components of test standard manufacturing apparatus 10. For example, the contaminant 136 may be introduced during abrading with abrading apparatus 106, during conversion coating application with conversion coating application apparatus 118, during primer application with primer application apparatus 124, and/or during compaction with compaction assembly 130. Contaminant 136 may alter the nature of the resulting adhesive bond in adhesive bonded joint 104. For example, contaminant 136 may weaken the strength of adhesive bonded joint 104. Non-exclusive examples of possible contaminants 136 include a mold release agent, silicone (e.g., silicone powder, silicone tape residue), existing topcoats and/or protective coatings (e.g., paint primer) that were not fully removed, hydrophobic contaminants, incorrect adhesive, pre-bond moisture, and/or hydrocarbon contaminants such as grease (e.g., tool grease).

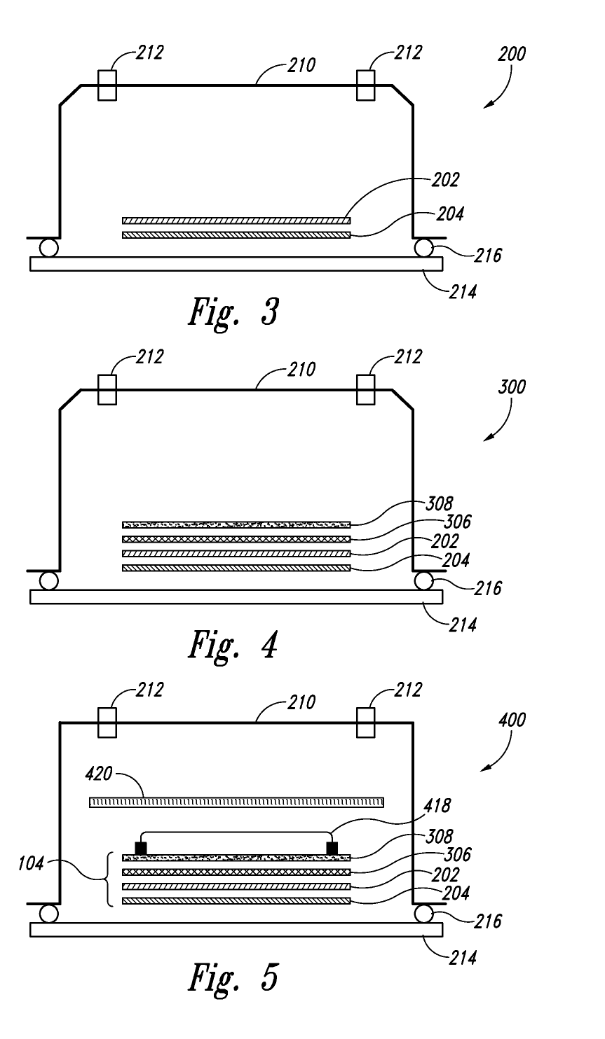

FIGS. 3-5 show exploded views of illustrative, non-exclusive examples of compaction methods that may be a part of compaction assembly 130 of FIG. 2, either alone or in combination, and may be altered according to the present disclosure to create and detect altered adhesive bonded joints. A first compaction 200 (FIG. 3) may be performed to apply an adhesive 202 to a repair surface 204 (e.g., an aluminum plate repair surface, abraded first substrate 103, or primed first substrate 111) for a first compaction time. The first compaction time may be a relatively short period of time, such as a period of 3-5 minutes. In the first compaction method 200, the repair surface 204 may be positioned on a support surface 214 (e.g., a caul plate) and surrounded by tacky tape 216 (also referred to as sealant tape 216 or bagging tape 216). Once the adhesive 202 is positioned on or applied to the repair surface 204, a vacuum bag 210 (e.g., a quick draw vacuum bag film; vacuum bag 210 may also be referred to as vacuum bag film 210) may be placed such that it covers or envelops the repair surface 204 and adhesive 202, and creates a seal around the repair surface 204 and adhesive 202 as the vacuum bag 210 is pressed against the tacky tape 216. One or more vacuum ports 212 may be provided to connect to a vacuum pump, which may be configured to remove air from within the vacuum bag 210, thereby squeezing or pressing the adhesive 202 onto the repair surface 204. As will be appreciated by one of ordinary skill in the art, additional layers of material (e.g., release film, breather cloth) may be present in first compaction 200 that are not shown in FIG. 2, for clarity. For example, layers configured to prevent the repair surface 204 from sticking to the support surface 214 and/or release layers positioned between the vacuum bag 210 and the adhesive 202 may be provided.

A second compaction 300 (FIG. 4) may be performed for a second compaction time and may function to compact a repair patch 308 (e.g., an aluminum plate patch, abraded second substrate 105, primed second substrate 113, or second substrate 102) onto the adhesive 202 and repair surface 204 of the first compaction 200 (FIG. 3). Second compaction 300 may include additional layers, such as a layer of positioning fabric 306 positioned between the repair patch 308 and the adhesive 202, as well as additional layers of materials not shown in FIG. 4, for clarity. As with first compaction 200, second compaction 300 may be performed on a support surface 214, with a vacuum bag 210 secured via tacky tape 216 in order to envelop the repair patch 308, positioning fabric 306, adhesive 202, and repair surface 204 and compact them together. The second compaction time may be an additional 3-5 minutes.

A cure bagging method 400 (FIG. 5) may be performed to complete the curing of adhesive 202 and/or any primer applied by primer application apparatus 124 of FIG. 2. The cure bagging method 400 also may be performed by compressing a plurality of layers (including patch 308, positioning fabric 306, adhesive 202, and repair surface 204) against a support surface 214 via vacuum bag 210 secured via bagging tape 216. Vacuum ports 212 may be coupled to a vacuum pump that may apply a vacuum to the cure bagging method 400, thereby compressing together adhesive 202, patch 308, and repair surface 204 to form an adhesive bonded joint 104. Cure bagging method 400 also may be subjected to heat, in order to cure the adhesive 202 and/or any primer present. For example, a heat blanket 420 may be positioned adjacent the adhesive bonded joint 104, within the vacuum bagging film 210, as shown in FIG. 5. Alternatively or additionally, an exterior heat blanket or other heating element may be provided outside the vacuum bag 210, and/or a different heat source (e.g., an oven, kiln, etc.) may be used to cure the adhesive 202 and/or any primer present. Cure bagging method 400 may also include one or more thermocouples 418 positioned to monitor the temperature within the cure bagging method 400.

Compactions 200, 300 and cure bagging method 400 may be configured to apply a vacuum to repair surface 204 and/or to repair patch 308 (e.g., via vacuum assembly 132 in FIG. 2) and/or to apply heat during curing (e.g., with curing apparatus 134 of FIG. 2). For example, a cure temperature of at least 200° F., at least 210° F., at least 220° F., at least 230° F., at least 240° F., at least 250° F., at least 260° F., at least 270° F., at least 280° F., at least 290° F., and/or at least 300° F. (at least 93° C., at least 98° C., at least 104° C., at least 110° C., at least 115° C., at least 121° C., at least 126° C., at least 132° C., at least 137° C., at least 143° C., and/or at least 148° C.) may be applied along with a vacuum of about 10-15 in Hg (about 254-381 mm Hg) to cure the adhesive and/or any primer in cure bagging method 400. One or both of compactions 200, 300 may serve as compaction assembly 130 as shown in FIG. 2. Likewise, cure bagging method 400 may serve as curing apparatus 134 in FIG. 2.

While FIGS. 3-5 show illustrative, non-exclusive examples of compaction and cure bagging methods, other methods also are possible and within the scope of the present disclosure. For example, compactions may be performed with a self-sealing heating blanket, which may allow for application of heat and vacuum directly to a repair surface without the need for a caul plate, tacky tape, or vacuum bag film material.

Test standard manufacturing apparatus 10 of FIG. 2, compactions 200, 300 of FIGS. 3-4, and/or cure bagging method 400 of FIG. 5 may be used to perform a number of different methods. For example, test standard manufacturing apparatus 10 may be used to perform a selected manufacturing process in order to produce an adhesive bonded joint of desired strength between a first and second metallic substrate and/or between two composite surfaces. In other methods, the test standard manufacturing apparatus may be used to perform different methods where one or more of the plurality of steps of the selected manufacturing process may be altered in order to produce an altered (e.g., weakened) adhesive bonded joint. For example, altering steps of a selected manufacturing process may result in altered adhesive bonds having less than 75%, less than 70%, less than 60%, less than 50%, less than 40%, less than 30%, less than 20%, or less than 10% of the strength of the reference adhesive bond that would normally be produced by the selected manufacturing process when it is performed without altering one of its steps.

Any combination of any or all of the steps of a selected manufacturing process may be altered in order to produce an altered adhesive bond according to the present disclosure. For example, one step of a selected manufacturing process may be altered. In other examples, two or more steps of a selected manufacturing process may be altered. For example, a first material may be substituted for a second material. In one specific example, a first primer type may be substituted for a second primer type. For example, a selected manufacturing process may recommend an epoxy-based primer (e.g., adhesive primer 126 in FIG. 2), and that step of the selected manufacturing process may be altered to use a different primer, such as a urethane-based primer (e.g., paint primer 128 in FIG. 2). The selected manufacturing process may be altered by substituting a material having a lower shear strength and/or a lower peel strength than that of the material recommended by the selected manufacturing process. Such material substitution may create a dispersive interface between the first and second substrates, may lower the surface energy of the first substrate and/or of the second substrate, may change the molecular attraction forces between the first and second substrates, and/or may increase a contact angle between an adhesive and the first substrate and/or between the adhesive and the second substrate.

Disclosed methods of selecting a manufacturing process and altering one or more of the steps of the selected manufacturing process during performance of the procedure may be repeated a plurality of times, thereby producing a plurality of altered adhesive bonds between a plurality of respective metallic or composite substrates. The same step or steps of the selected manufacturing process may be altered during each repetition. In other examples, a different step or set of steps may be altered during some of the repetitions. A threshold proportion of the plurality of altered adhesive bonds may be significantly weaker than the reference adhesive bond. For example, the threshold proportion of the plurality of altered adhesive bonds may be at least 50%, at least 75%, and/or at least 90% of the plurality of the altered adhesive bonds produced by repeating the altered manufacturing process and altering one or more of its steps. Further, the threshold proportion of significantly weaker altered adhesive bonds may be at least 20%, at least 30%, at least 40%, at least 50%, at least 60%, at least 70%, at least 80%, and/or at least 90% weaker than the reference adhesive bond that would be produced by the selected manufacturing process without altering one or more steps during performance.

One example of a selected manufacturing process may be selected that includes preparing the surface of first substrate 100 and/or second substrate 102 (e.g., wiping the surface(s) with a solvent and/or abrading or sanding the surface(s) with abrading apparatus 106), applying a conversion coating to the abraded first substrate 103 and/or the abraded second substrate 105 with the conversion coating application apparatus 118, applying an adhesive primer 126 to coated first substrate 107, coated second substrate 109, abraded first substrate 103, and/or abraded second substrate 105 with the primer application apparatus 124, and curing the substrates together (e.g., with compaction assembly 130 and curing apparatus 134) to produce a reference adhesive bonded joint.

Altering one or more steps of said selected manufacturing process may include: introducing or intentionally introducing a contaminant 136, sanding improperly (e.g., resulting in inadequate surface roughness) or intentionally sanding improperly via abrading apparatus 106, introducing or intentionally introducing an improper conversion coating via conversion coating application apparatus 118, altering or intentionally altering a primer via primer application apparatus 124, omitting or intentionally omitting a primer via primer application apparatus 124, curing improperly (e.g., under-curing or over-curing) or intentionally curing improperly via curing apparatus 134 and/or compaction assembly 130, removing moisture inadequately or intentionally removing moisture inadequately, cleaning the surfaces inadequately or intentionally cleaning the surfaces inadequately, applying adhesive after oxidation of the surface (e.g., too long after surface preparation according to the selected manufacturing process) or intentionally applying adhesive after oxidation of the surface, and/or using or intentionally using an improper adhesive via compaction assembly 130.

In one specific example, sanding improperly or intentionally sanding improperly may include abrading or intentionally abrading with a sanding means 108, 110, 112, 114, 116 other than 180-grit sandpaper, abrading or intentionally abrading for more than 30 seconds with a single sheet of sandpaper, waiting or intentionally waiting more than four hours between abrading and applying conversion coating parts 120, 122 and/or adhesive 144, waiting or intentionally waiting more than 24 hours between abrading and applying the conversion coating, polishing or intentionally polishing the surface after abrading, and/or polishing or intentionally polishing with, for example, a non-woven ceramic grain disc or sheet 117 after abrading with abrading apparatus 106. Sanding improperly may result in inadequate surface roughness of at least one of the substrate surfaces, which may result in a weakened adhesive bond.

Similarly, introducing or intentionally introducing an improper conversion coating may include applying or intentionally applying conversion coating parts 120, 122 for less than a minute, applying or intentionally applying conversion coating parts 120, 122 for less than 30 seconds, and/or applying or intentionally applying one of the first and second conversion coating parts 120, 122 without mixing it with the other of the first and second conversion coating parts 120, 122.

Altering or intentionally altering a primer may include substituting or intentionally substituting a different primer than the primer specified in the selected manufacturing process, mixing or intentionally mixing the primer inadequately, applying or intentionally applying the primer at a thickness of greater than 25 μm, and/or applying or intentionally applying the primer at a thickness of greater than 15 μm via the primer application apparatus 124. Omitting or intentionally omitting a primer may include omitting or intentionally omitting an adhesive primer 126 that is part of the selected manufacturing process.

Curing inadequately or intentionally curing inadequately may include curing or intentionally curing at a lower temperature than specified by the selected manufacturing process, curing or intentionally curing for less time than specified by the selected manufacturing process, curing or intentionally curing at a higher temperature than specified by the selected manufacturing process, and/or curing or intentionally curing for more time than specified by the selected manufacturing process via compaction assembly 130, vacuum assembly 132, and/or curing apparatus 134. Curing inadequately may include under-curing the adhesive primer 126 and/or adhesive 144, over-curing the adhesive primer 126 and/or adhesive 144, and curing at a different ramp rate than recommended by the selected manufacturing process.

Using or intentionally using an improper adhesive may include using or intentionally using an adhesive that is older than a recommended adhesive shelf life, using or intentionally using an adhesive that is at least nine months older than the recommended adhesive shelf life, using or intentionally using an adhesive that is at least 17 months older than the recommended adhesive shelf life, improperly storing or intentionally improperly storing the adhesive, storing or intentionally storing the adhesive out of a freezer for longer than a recommended time limit, storing or intentionally storing the adhesive out of a freezer for at least 400 hours longer than the recommended time limit, substituting a different adhesive than is specified by the manufacturing process, applying or intentionally applying the adhesive at a thickness other than that specified by the manufacturing process, applying or intentionally applying at least three plies of a film adhesive, and/or applying or intentionally applying at least five plies of a film adhesive.

Introducing or intentionally introducing a contaminant 136 may include introducing a contaminant 136 to at least one of the substrates (e.g., substrates 100, 102, 103, 105, 107, 109, 111, 113) via abrading apparatus 106, conversion coating application apparatus 118, primer application apparatus 124, and/or compaction assembly 130. Contaminant 136 may include pre-bond moisture, protective coatings (e.g., top coats, primers) pre-existing on one or more of the substrates 100, 102, 103, 105, 107, 109, 111, 113 that are not fully removed before application of the adhesive 144, paint primer, mold release agents, grease, silicone tape residue, dust, hydrophobic contaminants, and/or any substance or material that is not included in the selected manufacturing process.

An existing paint primer from the first substrate 100 and/or the second substrate 102 may be removed and a new layer of paint primer 128 may be applied via primer application apparatus 124 to at least one substrate (e.g., to coated first substrate 107, coated second substrate 109, abraded first substrate 103, and/or abraded second substrate 105). Additionally or alternatively, some methods may include preparing the first substrate 100 and/or the second substrate 102 for bonding and leaving at least some of an existing paint primer on the first substrate 100 and/or the second substrate 102, which paint primer may thereby function as a contaminant 136. For example, in methods where a patch or other repair is being performed on an existing part (e.g., rework on a metallic or composite surface previously in use as a component on, for example, an aircraft) with pre-existing paint and/or paint primer, in some methods, the existing paint and/or paint primer may be entirely removed before the rework manufacturing process is performed, and in other methods, at least some of the existing paint and/or paint primer may remain on the metallic substrate when the new/repair adhesive bonded joint is formed.

Removing moisture inadequately or intentionally removing moisture inadequately may include omitting moisture removal or inadequately removing moisture from the bonding surface (e.g., the surface of any substrates). Pre-bond moisture in the bonding region (e.g., the area of the substrates onto which adhesive has or will be applied) may exceed 0.3% and/or may exceed 0.9% in some examples.

Cleaning the surfaces inadequately or intentionally cleaning the surfaces inadequately may include incomplete removal of contaminants from tooling (e.g., tool grease, mold-release agents) and/or from silicone tape.

In some methods, the altered adhesive bond produced after altering one or more steps of a selected manufacturing process may be inspected. For example, a quantitative property of one or more altered adhesive bonds may be measured. Measurable quantitative properties may include peel strength, fracture toughness, tensile strength, modulus, and/or shear strength. Further, a non-destructive test to detect weak bonds or to determine whether the altered adhesive bond is significantly weaker than the reference adhesive bond may be developed. Such non-destructive tests may be created based on data 150 collected from intentionally created weakened adhesive bonded joints 104 according to the present disclosure.

Test standard manufacturing apparatus 10 may be used to make a test standard or test specimen, or a plurality of test specimens (e.g., a plurality of adhesive bonded joints 104), having an adhesive bond between a first substrate and a second substrate (e.g., between repair patch 308 and repair surface 204 in FIG. 4). Said adhesive bonded joints 104 may be tested to determine whether a strength of the bond of each of the test specimens is above or below a threshold value. One or more destructive tests may be performed, such as a peel test, a climbing drum peel test, a wedge test, a lap shear test, a paint conversion test, and/or a crack propagation test. Additionally or alternatively, one or more non-destructive tests may be performed, such as an ultrasonic test, a structural health monitoring test, a pulse-echo test, a thermography test, a shearography test, a laser bond inspection test, and/or a through-transmission ultrasonic test.

Such methods and apparatus described herein may be used to intentionally create poor in-service adhesive bonds that normally result from manufacturing defects and/or repair defects during rework techniques. For example, intentionally produced weakened adhesive bonds may perform substantially similarly to an accidental poor in-service adhesive bond in at least one quantitative performance test. At least one performance characteristic of each of a plurality of weakened adhesive bonded joints may be determined and data associated with said performance characteristics may be collected and stored in, for example, a database. The stored data may be used to develop a non-destructive test to detect poor in-service adhesive bonded joints. Such data may be used for a variety of purposes. For example, a database of repeatable methods may be created that may be used as a quality control check for a bonded rework associated with the repeatable methods. The database of repeatable methods may also be used to certify bonded rework on, for example, a primary structure of an aircraft. Furthermore, the data may be used to create at least one standard to certify at least one non-destructive analysis method for detecting weak bonds, such non-destructive analysis methods including structural health monitoring, ultrasonic through transmission, pulse echo, thermography, shearography, and laser bond inspection. The at least one non-destructive analysis method may be specific to an individual aircraft rework. Additionally or alternatively, new rework state decision logic may be developed to prevent in-service occurrence of weak adhesive bonds.

Data regarding intentionally created weak bonds may also be used to create a database cataloging weak bonding interfaces and their associated lifecycle deviations, perform predictive analysis based on the database of weak bonding interfaces, and/or develop one or more mitigation techniques using the database of weak bonding interfaces.

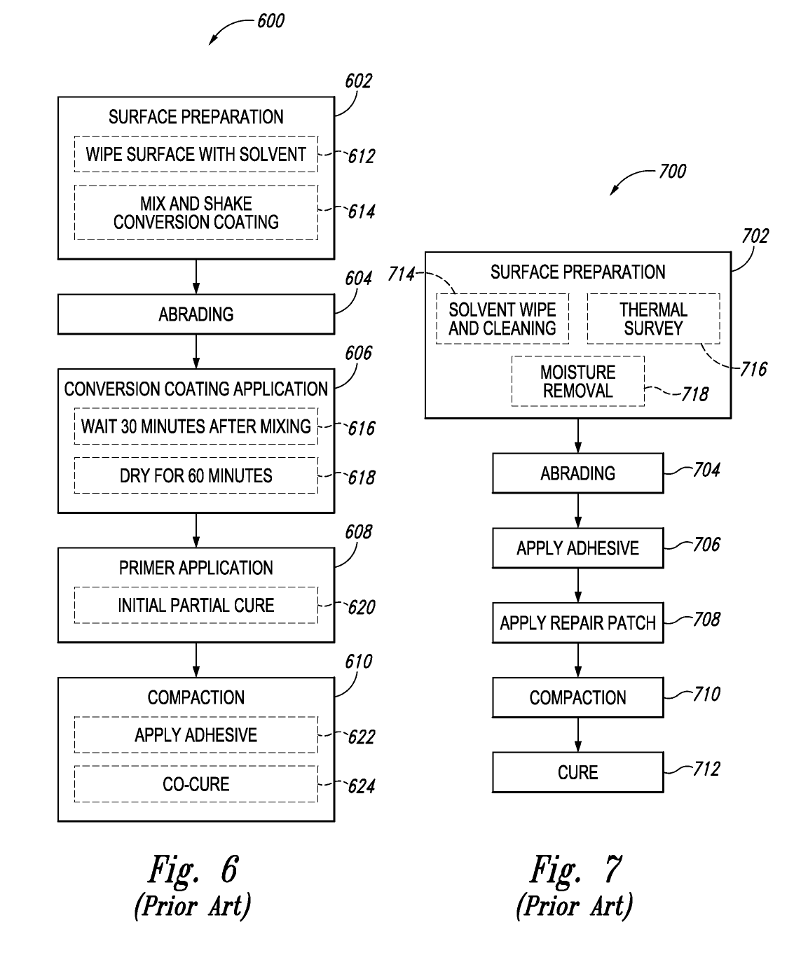

FIGS. 6-9 schematically provide flowcharts that represent illustrative, non-exclusive examples of methods according to the present disclosure. Some steps are illustrated in dashed boxes, indicating that such steps may be optional or may correspond to an optional version of a method according to the present disclosure. That said, not all methods according to the present disclosure are required to include the steps illustrated in solid boxes. The methods and steps illustrated in FIGS. 6-9 are not limiting and other methods and steps are within the scope of the present disclosure, including methods having greater than or fewer than the number of steps illustrated, as understood from the discussions herein.

FIG. 6 shows a flowchart of a high-level method of an example of a manufacturing process 600 to produce a metal adhesive bonded joint joining a first metallic substrate and a second metallic substrate. Manufacturing process 600 generally may include the steps of surface preparation 602, abrading 604 (also referred to herein as sanding 604), conversion coating application 606, primer application 608, and compaction 610. Surface preparation at 602 may prepare the surface of a first metallic substrate and/or a second metallic substrate for adhesively bonding the same together. Surface preparation at 602 may include cleaning the surface(s), such as by wiping the first metallic substrate and/or the second metallic substrate with a solvent (e.g., acetone) at 612. Surface preparation 602 may also include preparation of materials for later steps in the manufacturing process 600. For example, surface preparation 602 may include mixing and shaking first and second conversion coating parts together at 614 to prepare the conversion coating for later application.

After surface preparation 602, abrading at 604 may be performed to abrade the surfaces of the first metallic substrate and/or the second metallic substrate, such as with abrading apparatus 106 shown in FIG. 2. Abrading 604 may include fully removing existing surface treatments and/or coatings from a first and/or second metallic substrate that may serve as a repair surface and/or repair patch. For example, a repair surface for a given process 600 may be a repair surface from an aircraft having existing layers of paint, primer, and/or top coats. All such existing layers may be fully removed during abrading 604. Abrading 604 may be performed until the surface of the first metallic substrate and/or the second metallic substrate has a sufficient surface roughness to promote bonding. Abrading 604 may be performed with one or more sanding discs and/or one or more sheets of sandpaper. Abrading 604 may be performed in multiple different directions for a threshold abrading time in each direction. For example, abrading 604 may be performed such that a new sanding disc and/or sheet of sandpaper is used every 30 seconds, and the direction of abrasion is rotated 90 degrees with every new sanding disc and/or sheet of sandpaper. Abrading 604 may be performed with any grit of sandpaper or sanding disc sufficient to create the desired surface roughness, and may include 150 and/or 180 grit sandpaper and/or sanding disc.

After abrading at 604, conversion coating application at 606 may be performed to apply, for example, a mixture of sol-gel parts to the first metallic substrate and/or to the second metallic substrate, such as with conversion coating application apparatus 118 of FIG. 2. Conversion coating application at 606 may include waiting 30 minutes at 616 after the sol-gel parts were mixed and shaken at 614 during surface preparation 602. Conversion coating application 606 also may include allowing the conversion coating to dry for 60 minutes at 618 after application of the conversion coating mixture.

Primer application at 608 may be performed to apply a primer to the first metallic substrate and/or the second metallic substrate, such as an adhesive primer and/or a paint primer, such as with primer application apparatus 124 of FIG. 2. Primer application at 608 may include a process for verification of the thickness of the primer applied to the surface. Primer application 608 also may include an initial partial primer cure step at 620, wherein the primer is allowed to partially cure before the subsequent steps are performed.

Compaction at 610 then may be performed to form the metal adhesive bonded joint between the first metallic substrate and the second metallic substrate, such as with compaction assembly 130 of FIG. 2. Compaction at 610 may include one or more compactions wherein adhesive is applied at 622 and compressed against the first metallic substrate and/or the second metallic substrate. In one example, an adhesive may be applied at 622 to the first metallic substrate and compacted for 3-5 minutes. Then, the second metallic substrate may be compacted with the adhesive between it and the first metallic substrate for an additional 3-5 minutes. Finally, the adhesive and primer may be subjecting to vacuum and/or heat and allowed to fully co-cure at 624, thereby resulting in a cured adhesive bond or joint holding together the first metallic substrate and the second metallic substrate, such as with curing apparatus 134 of FIG. 2.

FIG. 7 shows a flowchart of a high-level method of an example of a manufacturing process 700 to produce an adhesive bonded joint joining a first composite substrate and a second composite substrate. Manufacturing process 700 generally may include steps of surface preparation 702, abrading 704, adhesive application 706, repair patch application 708, compaction 710, and curing 712.

Surface preparation at 702 may include a cleaning at 714, a thermal survey at 716, and/or a moisture removal at 718. Cleaning at 714 may include wiping or double wiping with a solvent (such as acetone) to clean the bonding surface. Cleaning at 714 may be performed to remove potential contaminants such as silicone tape residue, mold release agents, and/or tool grease. Thermal survey at 716 may be performed to identify any heat sinks and/or potential thermal management issues within the bonding region on the first and/or second composite substrate. Performing thermal survey 716 may help prevent areas of undercured adhesive in the bonding region. Moisture removal at 718 may be performed to substantially remove pre-bond moisture from the bonding region on the first and/or second composite substrates.

After surface preparation at 702, the surfaces of the first and/or second composite substrates may be roughened by abrading at 704, such as with abrading apparatus 106 of FIG. 2. For example, the repair region of the first composite substrate (e.g., the area of the first composite substrate to which adhesive and the second composite substrate will be applied) may be abraded to adequately roughen the repair region in preparation for bonding. Abrading at 704 may include abrading with one or more sanding discs and/or one or more sheets of sandpaper having a grit of 150-180, inclusive. An adhesive may be applied at 706 within 4 hours of completion of abrading at 704. Waiting more than 4 hours after abrading at 704 may allow oxidation of the abraded surface, thereby creating poor or diminished bonding conditions.

Once adhesive application 706 is performed, the repair patch (e.g., the second composite substrate) may be applied at 708 such that the adhesive is sandwiched between the first and second composite substrates. The thusly joined first and second composite substrates may be subject to one or more compactions at 710 to compress the substrates together (e.g., using compaction assembly 130 of FIG. 2), and the adhesive may be cured at 712, such as by placing under vacuum and subjected to heat sufficient to cure the adhesive (e.g., using curing apparatus 134 of FIG. 2). In some examples, the substrate-adhesive sandwich structure may be placed into a vacuum bag with thermocouples for temperature monitoring, and a heat blanket, to apply heat during curing at 712, thereby resulting in an adhesive bonded joint joining the first and second composite substrates.

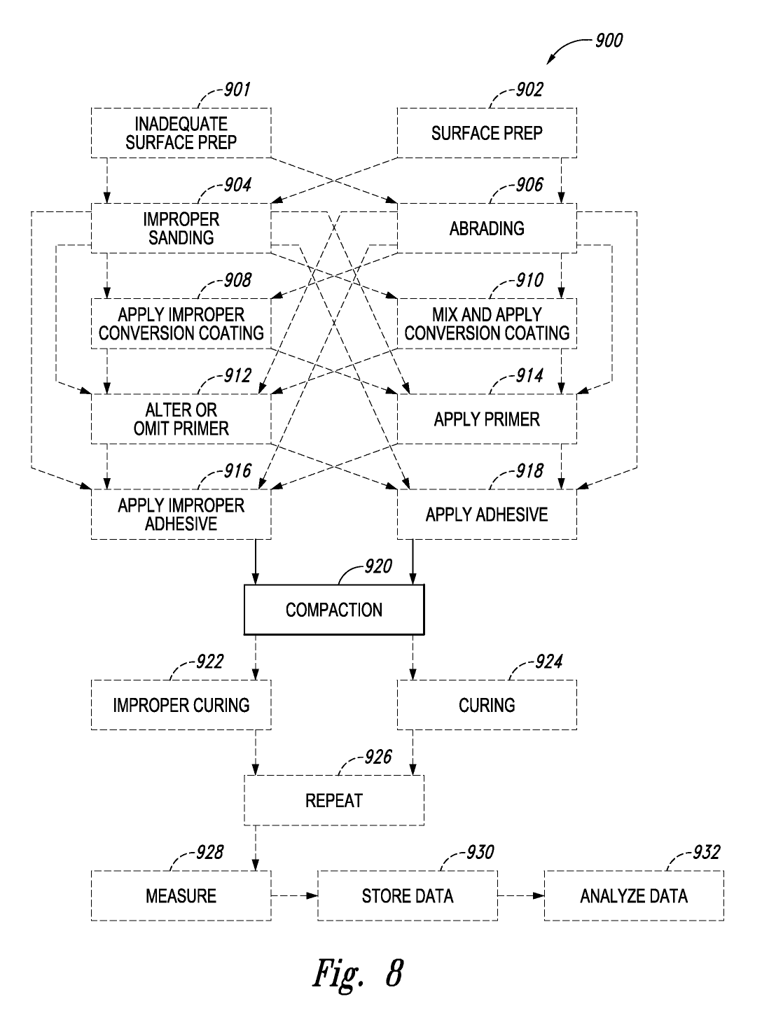

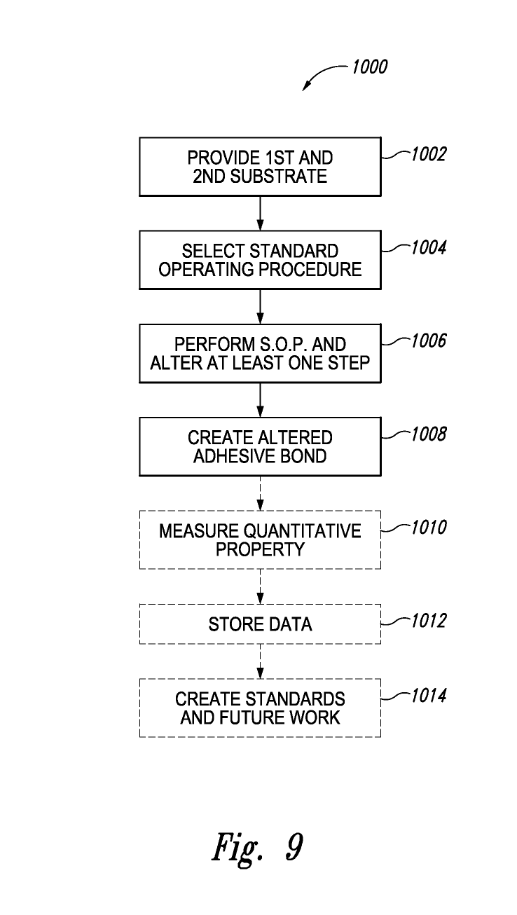

According to the present disclosure, a manufacturing process, such as those described above in connection with FIGS. 6 and 7, may be intentionally altered in order to produce an altered adhesive bonded joint. As used herein, “intentional” or “intentionally” means with purpose, or with a purpose, such as with the purpose of deviating from a manufacturing process and/or with the purpose of creating an altered or weakened adhesive bond. For example, deviations from the manufacturing process may create an altered or weakened adhesive bond between the first (metallic or composite) substrate and the second (metallic or composite) substrate. FIGS. 8 and 9 illustrate non-exclusive examples of such methods 900, 1000 that may be used to create an altered adhesive bonded joint (e.g., a weakened adhesive bonded joint) between a first substrate and a second substrate.

As shown in FIG. 8, method 900 may begin with performance of a surface preparation step 902 (e.g., surface preparation 602 (FIG. 6) or surface preparation 702 (FIG. 7)) or inadequate surface preparation 901. Inadequate surface preparation at 901 may include insufficiently cleaning the bonding surface of the first and/or second metallic substrate. For example, inadequate surface preparation 901 may result in contaminants not being removed before bonding, and therefore may result in introduction of contaminants to the adhesive bonded joint. In some examples, inadequate surface preparation 901 (e.g., inadequate cleaning) may result in insufficiently removing hydrophobic contaminants such as grease (e.g., tool grease), mold-release agents, or silicone (e.g., silicone tape residue) from the bonding region. Inadequate surface preparation 901 may include intentionally introducing said contaminants. In a specific example, inadequate surface preparation 901 may include intentionally introducing specific quantities of a contaminant to simulate inadequate cleaning. For example, grease may be introduced in specific percentages (e.g., 0.3%, 0.5%, 1%) as part of inadequate surface preparation step 901. Precise weighting techniques may be performed to accurately determine the amount of any hydrophobic contamination present, such data being available to be stored and analyzed as desired.

Additionally or alternatively, inadequate surface preparation at 901 may include omitting the thermal survey and/or moisture removal that may be part of a selected manufacturing process. When inadequate surface preparation 901 includes omitting moisture removal, the bonding region may include pre-bond moisture that may interfere with bonding. Moisture removal may be partially performed, so that a desired amount of pre-bond moisture is present in the bonding region. For example, inadequate surface preparation 901 may leave up to 0.3%, at least 0.3%, at least 0.9%, or greater than 0.9% moisture in the bonding region. Humidity chambers may be used to increase the pre-bond moisture content in some inadequate surface preparation steps 901.

After performing either inadequate surface preparation at 901 or surface preparation at 902, an abrading step may be performed that is either abrading at 906 according to a selected manufacturing process, or improper sanding at 904. For example, in one manufacturing process, abrading 906 may include abrading the surface of a first substrate and/or a second substrate with a series of 5 different sheets of sand paper of a specified grit and type for 30 seconds each, in different directions. Improper sanding at 904 may include sanding with the wrong type of sandpaper or sanding disc (e.g., sanding with one or more sheets of sandpaper and/or one or more sanding discs having a grit different than the grit recommended by the selected manufacturing process, and/or sanding with a sandpaper and/or sanding disc different from a specific sandpaper or sanding disc recommended by the selected manufacturing process), not changing the sheet of sandpaper and/or sanding disc often enough, not sanding for long enough in each direction, or not changing directions of sanding according to the selected manufacturing process. Additionally or alternatively, improper sanding at 904 may include omitting the abrading step altogether, polishing the surface with a ceramic polishing material, and/or insufficiently roughening the surface of the first and/or second substrate. In one specific example, improper sanding at 904 may include using 220-grit sandpaper (or sanding disc) when a selected manufacturing process recommends using 150-180 grit sandpaper (or sanding disc). Additionally or alternatively, improper sanding at 904 may include incomplete removal of one or more pre-existing layers on the first or second substrate (e.g., pre-existing paint, primer, protective coatings, and/or top coats).

After either abrading at 906 or improper sanding at 904, each of which are optional steps in method 900, a conversion coating mixture may be applied according to a selected manufacturing process at 910 or an improper conversion coating may be applied at 908. For example, in a selected manufacturing process, two conversion coating parts may be mixed and allowed to rest for at least 30 minutes before being applied to a first metallic substrate and/or a second metallic substrate at 910. Alternatively, in the application of an improper conversion coating at 908, the first or second conversion coating part may be omitted, or the conversion coating mixture may be applied to the first metallic substrate and/or the second metallic substrate without waiting an appropriate amount of time after mixing the conversion coating parts, to result in an improper conversion coating at 908. Generally, neither of steps 908 and 910 is performed when the substrates are composite substrates.

After either application of the improper conversion coating at 908, mixing and application of the conversion coating at 910, abrading at 906, or improper sanding at 904, a primer may be applied according to a selected manufacturing process at 914 or the primer may be omitted or altered at 912. For example, an adhesive primer may be applied to the surface of the first substrate and/or the second substrate at least 60 minutes after application of a conversion coating mixture at 910 in one example of primer application at 914. Alternatively, a different primer may be applied, the primer may be applied at the wrong time, or the primer may be omitted entirely at 912. For example, a paint primer may be applied to the surface of the first substrate and/or the second substrate instead of an adhesive primer recommended in the selected manufacturing process, when altering the primer at 912. In other examples, an existing paint primer on the first substrate and/or second substrate may not be fully removed during abrading 906 or improper sanding 904. In methods involving composite substrates, an adhesive may be applied to the first and/or second substrate directly after abrading 906 or improper sanding 904. Both primer application 914 and altering or omitting a primer 912 may be optional and not performed in some methods when working with composite substrates.

An adhesive may be applied to the first substrate and/or the second substrate, such as applying an adhesive according to a selected manufacturing process 918 or applying an improper adhesive 916. For example, a film adhesive may be applied according to a selected manufacturing process at 918. In other examples, a different adhesive may be applied at 916 to the first substrate and/or the second substrate (e.g., an adhesive other than that recommended by the selected manufacturing process). Additionally or alternatively, applying an improper adhesive 916 may include applying adhesive more than 4 hours after abrading 906 or improper sanding 904, applying adhesive to a surface that has oxidized, applying an adhesive that has been improperly stored, staging the adhesive (e.g., heating it and allowing it to rest at a given temperature before the patch is applied, thereby allowing volatiles to flash off and reducing bonding ability), applying an adhesive that has been out of the freezer for longer than recommended by a selected manufacturing process, and/or applying an adhesive that is out of date (e.g., beyond its shelf life, or older than an expiration date of the adhesive).

After the adhesive is applied either improperly at 916 or according to a selected manufacturing process at 918, at least one compaction may be performed at 920. For example, two compactions may be performed; a first compaction to apply the adhesive to one of the first substrate and the second substrate, and the second compaction to compact the other of the first substrate and the second substrate together with the adhesive being located therebetween. Each of the compactions may last for a short period of time, such as approximately 3-5 minutes.

After compaction 920, curing may be performed according to a manufacturing process at 924 or an improper curing step may be performed at 922. For example, curing 924 may include curing the compacted adhesive bonded joint in a vacuum of about 14 in Hg (355 mm Hg) for about 90 minutes, at a temperature of about 240-260° F. (115-127° C.), according to a selected manufacturing process. Alternatively, improper curing 922 may be performed and may include curing at a lower or higher temperature than recommended by the selected manufacturing process (e.g., a temperature at least 5 degrees higher or lower than the recommended curing temperature range, such as below 235° F. or above 265° F.), curing at a different ramp rate (e.g., ramping up to the cure temperature at a rate higher or lower than that recommended by the selected manufacturing process, such as at a rate of at least 10° F. per minute or at a rate of less than 3° F. per minute if a selected manufacturing process recommends a ramp rate of 5° F. per minute), curing at a different vacuum pressure (e.g., curing at or below 10 in Hg or curing at or above 18 in Hg if a selected manufacturing process recommends curing at 14 in Hg), and/or curing for a longer or shorter period of time than is recommended by a manufacturing process (e.g., curing for less than 85 minutes or curing for more than 95 minutes if a selected manufacturing process recommends curing for 90 minutes). Additionally or alternatively, improper curing 922 may include monitoring the curing process poorly, undercuring the adhesive and/or primer, and/or overcuring the adhesive and/or primer.

After curing 924 or improper curing 922, method 900 may be repeated at 926 in order to produce a plurality of metal adhesive bonded joints according to a selected manufacturing process and/or to produce a plurality of metal adhesive bonded joints having a weakened or otherwise altered adhesive bond. Method 900 may be repeated a plurality of times such that method 900 is repeated the same way each time or such that method 900 may be performed in any of the possible ways each time it is repeated.

Repeating 926 a plurality of times (e.g., repeating any combination of steps 901, 902, 904, 906, 908, 910, 912, 914, 916, 918, 920, 922, and/or 924) may result in a plurality of altered adhesive bonds. Such bonds may be inspected, and data from said bonds measured at 928 (e.g., using a test 148 of FIG. 2). Such data may include data related to intentional alterations performed during performance of the selected manufacturing process, as well as bond strength data from the resulting adhesive bonds. Said data may be stored at 930, such as in a computer database (e.g., database 152 of FIG. 2) and analyzed at 932 to create standards and/or non-destructive inspection techniques as described herein.

FIG. 9 illustrates an exemplary method 1000 of creating an altered adhesive bond between a first substrate and a second substrate. For example, a first substrate and a second substrate may be provided at 1002. A manufacturing process (also referred to as a standard operating procedure) may be selected at 1004 and then the manufacturing process may be performed except that at least one step of the manufacturing process may be altered at 1006 so that at least one step of the manufacturing process is performed differently than is recommended by the manufacturing process. For example, a manufacturing process may be selected at 1004 having the steps of surface preparation 902, abrading 906, mixing and applying a conversion coating 910, primer application 914, adhesive application 918, compaction 920, and curing 924, as shown in FIG. 8. In this example, altering at least one step of the selected manufacturing process at 1006 may include performing inadequate surface preparation 901 instead of surface preparation 902, performing improper sanding 904 instead of abrading 906, applying improper conversion coating at 908 instead of mixing and applying a conversion coating at 910, altering or omitting a primer at 912 instead of applying primer at 914, applying improper adhesive 916 instead of applying adhesive 918, and/or performing improper curing at 922 instead of curing 924.

As a result of altering at least one step during performance of a selected manufacturing process, an altered adhesive bond between the first substrate and the second substrate thereby may be created at 1008. The altered adhesive bond may serve as an imitation weak bond in a parent structural panel, and thus method 1000 may function as a method of fabricating a weak adhesive bond that may imitate an in-service accidental weak bond. As shown in dashed lines in FIG. 9, the altered adhesive bond may be inspected and a quantitative property of the altered adhesive bond optionally may be measured at 1010, such as by using a test (e.g., a destructive or non-destructive test, such as test 148 of FIG. 2). In some methods, data regarding the altered adhesive bond may be stored at 1012, such as in a computer database (e.g., database 152 of FIG. 2), and such data may be analyzed and used for future work at 1014.

For example, stored data may be used to create a certification for bonded rework on primary structures of aircrafts, create standards to certify non-destructive analysis methods specific to each aircraft rework, and/or develop new rework state decision logics to prevent in-service occurrence of weakened adhesive bonds between substrates. Future work 1014 also may include testing the altered adhesive bonds to determine a relationship between bond strength and the degree of contamination introduced to the altered bond. Additionally or alternatively, future work 1014 may include one or more of development of methods to control the extent of the weakness of the bond, verification of non-destructive bonded structure testing, development of non-destructive inspection techniques to measure the strength of bonded structures, development of non-destructive inspection techniques to detect weak bonds, and development of non-destructive inspection techniques to prove strong bonds.

Illustrative, non-exclusive examples of inventive subject matter according to the present disclosure are described in the following enumerated paragraphs:

A1. A method of creating an altered adhesive bond between two substrates, the method comprising:

providing a first substrate and a second substrate;

selecting a manufacturing process having a plurality of steps, wherein the manufacturing process is designed to produce a reference adhesive bond between the first substrate and the second substrate, the reference adhesive bond having a desired strength;

altering at least one of the plurality of steps of the manufacturing process to produce at least one altered step; and

performing the manufacturing process with the at least one altered step to produce an altered bond between the first substrate and the second substrate.

A2. The method of paragraph A1, wherein the first substrate is a first composite substrate and the second substrate is a second composite substrate.

A3. The method of paragraph A1, wherein the first substrate is a first metallic substrate and the second substrate is a second metallic substrate.

A4. The method of any of paragraphs A1-A3, wherein the altered bond is weaker than the reference adhesive bond.

A5. The method of any of paragraphs A1-A4, wherein the altering at least one of the plurality of steps comprises substituting a first primer type for a second primer type.

A6. The method of any of paragraphs A1-A5, wherein the altering at least one of the plurality of steps comprises substituting a urethane-based primer for an epoxy-based primer.

A7. The method of any of paragraphs A1-A6, wherein the altering at least one of the plurality of steps comprises substituting a paint primer for an adhesive primer.

A8. The method of any of paragraphs A1-A7, wherein the altering at least one of the plurality of steps comprises substituting a first material for a second material.

A9. The method of paragraph A8, wherein the first material has a lower shear strength and/or a lower peel strength than the second material.

A10. The method of any of paragraphs A1-A9, wherein the altering at least one of the plurality of steps comprises creating a dispersive interface between the first substrate and the second substrate.

A11. The method of any of paragraphs A1-A10, wherein the altering at least one of the plurality of steps comprises lowering the surface energy of at least one of the first substrate and the second substrate.

A12. The method of any of paragraphs A1-A11, wherein the manufacturing process includes an application of an adhesive between the first substrate and the second substrate, wherein the adhesive has a first inherent contact angle between it and the first substrate and a second inherent contact angle between it and the second substrate, and wherein the altering at least one of the plurality of steps comprises increasing at least one of the first inherent contact angle and the second inherent contact angle.

A13. The method of paragraph A12, wherein at least one of the first inherent contact angle and the second inherent contact angle is increased.

A14. The method of any of paragraphs A1-A13, wherein the manufacturing process includes the application of the adhesive to bond the first substrate and the second substrate to one another.

A15. The method of any of paragraphs A1-A14, wherein the altered bond between the first substrate and the second substrate has less than 75%, less than 70%, less than 60%, less than 50%, less than 40%, less than 30%, less than 20%, or less than 10% of the strength of the reference adhesive bond.

A16. The method of any of paragraphs A1-A15, further comprising inspecting the altered bond.

A17. The method of any of paragraphs A1-A16, further comprising measuring a quantitative property of the altered bond.

A18. The method of paragraph A17, wherein the quantitative property is at least one of shear strength, peel torque, fracture strength, crack length, and crack propagation.

A19. The method of any of paragraphs A1-A18, further comprising repeating the performing the manufacturing process a plurality of times, repeating the altering at least one of the plurality of steps of the manufacturing process the plurality of times, and producing a plurality of altered bonds between a plurality of substrates, respectively.

A20. The method of paragraph A19, wherein the repeating the altering at least one of the plurality of steps of the manufacturing process the plurality of times comprises altering a same step each of the plurality of times.

A21. The method of paragraph A19, wherein the repeating the altering at least one of the plurality of steps of the manufacturing process the plurality of times comprises altering at least two different steps.

A22. The method of any of paragraphs A19-A21, wherein the repeating the altering at least one of the plurality of steps of the manufacturing process comprises altering such that at least a threshold proportion of the plurality of altered bonds are significantly weaker than the reference adhesive bond, optionally wherein the threshold proportion of the plurality of altered bonds is at least 50%, at least 75%, and/or at least 90% of the plurality of altered bonds.

A23. The method of paragraph A22, wherein the repeating the altering at least one of the plurality of steps of the manufacturing process comprises altering such that the threshold proportion of the plurality of altered bonds is at least 20%, at least 30%, at least 40%, at least 50%, at least 60%, at least 70%, at least 80%, and/or at least 90% weaker than the reference adhesive bond.

A24. The method of any of paragraphs A1-A23, further comprising developing a non-destructive test to determine whether the altered bonds are significantly weaker than the reference adhesive bond.

A25. The method of any of paragraphs A1-A24, wherein the manufacturing process is designed to create a bonded joint for use in at least one of aviation, automotive, and wind energy industries.

A26. The method of any of paragraphs A1-A25, wherein the manufacturing process includes preparation of the surface of the first substrate and/or the second substrate and application of heat to the first substrate and the second substrates together in a vacuum to produce and cure the reference adhesive bond.

A27. The method of paragraph A26, wherein the preparation of the surface of the first substrate and/or the second substrate includes at least one of a wiping of at least one of the first substrate and the second substrate with a solvent, an abrasion of at least one of the first substrate and the second substrate, and a removal of dust from at least one of the first substrate and the second substrate with compressed air.

A28. The method of paragraph A27, wherein the abrasion of at least one of the first substrate and the second substrate includes abrasion performed with sandpaper.

A29. The method of paragraph A27, wherein the abrasion of at least one of the first substrate and the second substrate includes a first abrasion of at least one of the first substrate and the second substrate in a first direction for a minimum of 30 seconds using a first sheet of sandpaper, a second abrasion of at least one of the first substrate and the second substrate in a second direction for a minimum of 30 seconds using a second sheet of sandpaper, where the second direction is substantially perpendicular to the first direction, a third abrasion of at least one of the first substrate and the second substrate in the first direction for a minimum of 30 seconds using a third sheet of sandpaper, a fourth abrasion of at least one of the first substrate and the second substrate in the second direction for a minimum of 30 seconds using a fourth sheet of sandpaper, and a fifth abrasion of at least one of the first substrate and the second substrate using a fifth sheet of sandpaper for a minimum of 30 seconds.

A30. The method of any of paragraphs A27-A29, wherein the abrasion of at least one of the first substrate and the second substrate includes abrasion with at least one of 150-grit sandpaper, 180-grit sandpaper, and sandpaper having a grit of between 150 and 180.

A31. The method of any of paragraphs A27-A30, wherein the solvent is acetone.

A32. The method of any of paragraphs A26-A31, wherein the manufacturing process includes a mixing of a first conversion coating part and a second conversion coating part together to produce a conversion coating, a shaking of the conversion coating for 15 seconds, and an application of the conversion coating to at least one of the first substrate and the second substrate, wherein the mixing of the first conversion coating part and the second conversion coating part and the shaking of the conversion coating are performed prior to preparation of the surface of at least one of the first substrate and the second substrate.

A33. The method of paragraph A32, wherein the conversion coating is applied within a threshold coating time after the preparation of the surface of at least one of the first substrate and the second substrate.

A34. The method of paragraph A33, wherein the threshold coating time is a maximum of 30 minutes, a maximum of 60 minutes, a maximum of 90 minutes, a maximum of 120 minutes, a maximum of 150 minutes, a maximum of 180 minutes, a maximum of 240 minutes, or a maximum of 300 minutes.

A35. The method of any of paragraphs A32-A34, wherein the application of the conversion coating includes substantially continuous application of the conversion coating to at least one of the first substrate and the second substrate for a threshold conversion coating application time, optionally wherein the threshold conversion coating application time is at least 1 minute or at least 2 minutes.

A36. The method of any of paragraphs A32-A35, wherein the manufacturing process further includes a drainage of excess conversion coating off of at least one of the first substrate and the second substrate for a threshold conversion coating draining time, optionally wherein the threshold conversion coating draining time is at least 2 minutes, at least 5 minutes, or at least 10 minutes.

A37. The method of any of paragraphs A32-A36, wherein the manufacturing process further includes an allowance of the conversion coating to dry for a threshold conversion coating drying time, optionally wherein the threshold conversion coating drying time is at least 30 minutes, at least 60 minutes, at least 90 minutes, or at least 120 minutes.

A38. The method of any of paragraphs A1-A37, wherein the manufacturing process further includes an application of an adhesive primer to at least one of the first substrate and the second substrate.

A39. The method of paragraph A38, wherein the adhesive primer is applied between 30 minutes and 48 hours after the application of the conversion coating.

A40. The method of any of paragraphs A38-A39, wherein the adhesive primer is a corrosion-inhibiting adhesive primer.

A41. The method of any of paragraphs A38-A40, wherein the manufacturing process further includes a removal of the adhesive primer from refrigeration, an allowance of the adhesive primer to reach between 15° C. and 40° C., a mixing of the adhesive primer in its original container, a transfer of the adhesive primer to a reservoir, and an agitation of the adhesive primer during the application of the adhesive primer.

A42. The method of any of paragraphs A38-A41, wherein the application of the adhesive primer includes a spray application of the adhesive primer on at least one of the first substrate and the second substrate to a thickness of between 3.8 μm and 10.2 μm.

A43. The method of any of paragraphs A26-A42, wherein the manufacturing process further includes application of heat sufficient to bring the adhesive primer to a temperature of between 48° C. and 66° C. for between 30 and 60 minutes.

A44. The method of any of paragraphs A1-A43, wherein the manufacturing process further includes application of the adhesive to at least one of the first substrate and the second substrate.

A45. The method of paragraph A44, wherein the application of the adhesive includes application of a film adhesive to at least one of the first substrate and the second substrate.

A46. The method of paragraph A45, wherein the film adhesive is a moisture-resistant, toughened, modified epoxy film.

A47. The method of any of paragraphs A44-A46, wherein the manufacturing process further includes application of heat to the adhesive primer and the adhesive in a vacuum of at least 14 in Hg, wherein the heat is sufficient to bring the adhesive primer and the adhesive to a temperature of between 115° C. and 133° C. for 90 minutes.

A48. The method of any of paragraphs A1-A47, wherein the altering at least one of the plurality of steps comprises at least one of: preparing the surface inadequately or intentionally preparing the surface inadequately, introducing or intentionally introducing a contaminant, sanding improperly or intentionally sanding improperly, introducing or intentionally introducing an improper conversion coating, altering or intentionally altering a primer, omitting or intentionally omitting a primer, curing inadequately or intentionally curing inadequately, incompletely removing or intentionally incompletely removing an existing paint primer from at least one of the first substrate and the second substrate, and using or intentionally using an improper adhesive.

A49. The method of paragraph A48, wherein the introducing or intentionally introducing the contaminant comprises introducing or intentionally introducing at least one of a mold release agent, silicone, moisture, silicon tape residue, and grease into the altered adhesive bond.

A50. The method of any of paragraphs A48-A49, wherein the sanding improperly or intentionally sanding improperly includes at least one of abrading or intentionally abrading with a sandpaper other than 180-grit sandpaper, abrading or intentionally abrading with a sandpaper having a grit lower than 150, abrading or intentionally abrading with a sandpaper having a grit higher than 180, abrading or intentionally abrading with a sandpaper having a grit of 220, omitting abrading, abrading or intentionally abrading for more than 30 seconds with a single sheet of sandpaper, waiting or intentionally waiting more than four hours between abrading and applying a conversion coating, waiting or intentionally waiting more than 24 hours between abrading and applying a conversion coating, polishing or intentionally polishing the surface after abrading, and polishing or intentionally polishing with a non-woven ceramic grain disc or sheet after abrading.

A51. The method of any of paragraphs A48-A50, wherein the introducing or intentionally introducing the improper conversion coating comprises at least one of applying or intentionally applying the conversion coating for less than a minute, applying or intentionally applying the conversion coating for less than 30 seconds, and applying or intentionally applying one of the first and second conversion coating parts without mixing it with the other of the first and second conversion coating parts.

A52. The method of any of paragraphs A48-A51, wherein the altering or intentionally altering the primer comprises at least one of substituting or intentionally substituting a different primer than the primer recommended in the selected manufacturing process, mixing or intentionally mixing the primer inadequately, applying or intentionally applying the primer at a thickness of greater than 25 μm, and applying or intentionally applying the primer at a thickness of greater than 15 μm.

A53. The method of any of paragraphs A48-A52, wherein the omitting or intentionally omitting the primer comprises omitting or intentionally omitting an adhesive primer that is part of the selected manufacturing process.

A54. The method of any of paragraphs A48-A53, wherein the curing inadequately or intentionally curing inadequately comprises at least one of curing or intentionally curing at a lower temperature than recommended by the selected manufacturing process, curing or intentionally curing for less time than recommended by the selected manufacturing process, curing or intentionally curing at a higher temperature than recommended by the selected manufacturing process, undercuring or intentionally undercuring the adhesive, overcuring or intentionally overcuring the adhesive, and curing or intentionally curing for more time than recommended by the selected manufacturing process.

A55. The method of any of paragraphs A48-A54, wherein the using or intentionally using tan improper adhesive comprises at least one of using or intentionally using an adhesive that is older than a recommended adhesive shelf life, using or intentionally using an adhesive that is at least nine months older than the recommended adhesive shelf life, using or intentionally using an adhesive that is at least 17 months older than the recommended adhesive shelf life, improperly storing or intentionally improperly storing the adhesive, storing or intentionally storing the adhesive out of a freezer for longer than a recommended time limit, storing or intentionally storing the adhesive out of a freezer for at least 400 hours longer than the recommended time limit, substituting a different adhesive than the adhesive recommended by the selected manufacturing process, applying or intentionally applying the adhesive at a thickness other than that specified by the selected manufacturing process, applying or intentionally applying at least three plies of adhesive, and applying or intentionally applying at least five plies of adhesive.

A56. The method of any of paragraphs A1-A55, wherein the altering the at least one of the plurality of steps comprises removing an existing paint primer from at least one of the first substrate and the second substrate and applying a new layer of paint primer to at least one of the first substrate and the second substrate.

A57. The method of any of paragraphs A1-A56, wherein the altering the at least one of the plurality of steps comprises preparing at least one of the first substrate and the second substrate for bonding, and leaving at least some of an existing paint primer on at least one of the first substrate and the second substrate.

A58. The method of any of paragraphs A48-A57, wherein the preparing the surface inadequately or intentionally preparing the surface inadequately comprises at least one of cleaning inadequately or intentionally cleaning inadequately, inadequately performing moisture removal or intentionally inadequately performing moisture removal, omitting or intentionally omitting a moisture removal procedure, allowing or intentionally allowing oxidation to occur on at least one of the first substrate and the second substrate, and applying adhesive or intentionally applying adhesive more than 4 hours after surface preparation.

A59. The method of any of paragraphs A1-A58, wherein one of the first substrate and the second substrate is a metallic substrate and one of the first substrate and the second substrate is a composite substrate.

B1. A method of reliably creating weakened adhesive bonded joints, comprising:

providing a first substrate and a second substrate; and

bonding the first substrate and the second substrate to one another with an adhesive to form a bonded joint, wherein the bonded joint is intentionally made weaker than a prescribed reference for the bonded joint, thereby forming an intentionally weak bonded joint.

B2. The method of paragraph B1, further comprising inspecting the bonded joint.

B3. The method of paragraph B1 or B2, further comprising measuring the strength of the bonded joint.

B4. The method of any of paragraphs B1-B3, further comprising repeating the providing the first substrate and the second substrate and repeating the bonding the first substrate and the second substrate to one another to form a plurality of bonded joints.

B5. The method of any of paragraphs B1-B4, further comprising developing a non-destructive testing protocol to detect weak bonds based on the intentionally weak bonded joint.

B6. The method of any of paragraphs B1-B5, wherein the bonding the first substrate and the second substrate comprises intentionally performing one or more of the following: introducing a contaminant, improper or inadequate sanding, improper or inadequate cleaning, improper or inadequate surface preparation, improper or inadequate conversion coating, omitting a primer, using an improper primer, inadequate or improper curing, inadequate or improper moisture removal, and using inadequate or improper adhesives.

B7. The method of any of paragraphs B1-B6, wherein the bonding the first substrate and the second substrate comprises intentionally providing a dispersive interface between the first and second substrate to weaken the bonded joint.

B8. The method of any of paragraphs B1-B7, wherein the bonding the first substrate and the second substrate comprises intentionally providing a material having a low shear strength and/or a low peel strength between the first and second substrates to weaken the bonded joint.

B9. The method of any of paragraphs B1-B8, wherein the bonding the first substrate and the second substrate comprises intentionally providing a urethane-based primer between the first and second substrates to weaken the bonded joint.

B10. The method of any of paragraphs B1-B9, wherein the bonding the first substrate and the second substrate to one another with the adhesive comprises the method of any of paragraphs A1-A59.

B11. The method of any of paragraphs B6-B10, wherein the introducing the contaminant comprises at least one of introducing moisture, inadequately removing moisture, introducing a mold-release agent, introducing grease, inadequately cleaning at least one of the first substrate and the second substrate, inadequately removing a mold-release agent, inadequately removing a grease, inadequately removing a tape residue, introducing a tape residue, and incomplete removal of an existing paint primer.

B12. The method of any of paragraphs B1-B11, wherein the first substrate is a first metallic substrate and the second substrate is a second metallic substrate.

B13. The method of any of paragraphs B1-B11, wherein the first substrate is a first composite substrate and the second substrate is a second composite substrate.

C1. A method of testing a bonded joint, the method comprising:

making a test specimen, the test specimen comprising at least a first substrate and a second substrate having an adhesive bond therebetween; and

determining whether a strength of the adhesive bond of the test specimen is above or below a threshold value, wherein the determining is performed using a test.

C2. The method of paragraph C1, wherein the making the test specimen comprises making a plurality of test specimens, and the determining comprises determining whether the strength of each adhesive bond of each of the plurality of test specimens is above or below the threshold value.

C3. The method of paragraph C1 or C2, further comprising detecting a weak bond in at least one test specimen.

C4. The method of any of paragraphs C1-C3, wherein the test comprises a destructive test, optionally wherein the destructive test comprises at least one of a peel test, a climbing drum peel test, a wedge peel test, a lap shear test, a paint conversion test, and a crack propagation test.

C5. The method of any of paragraphs C1-C3, wherein the test comprises a non-destructive test, optionally wherein the non-destructive test comprises at least one of an ultrasonic test, a structural health monitoring test, a pulse-echo test, a thermography test, a shearography test, a laser bond inspection test, and a through-transmission ultrasonic test.

C6. The method of any of paragraphs C1-C4, wherein the making the test specimen comprises selecting a manufacturing process having a plurality of steps, intentionally altering at least one of the plurality of steps of the selected manufacturing process so that it is different from the selected manufacturing process, and performing the selected manufacturing process with at least one altered step.

C7. The method of any of paragraphs C1-C6, further comprising performing the method of any of paragraphs A1-B10.

D1. A method of simulating poor in-service adhesive bonds that may result from manufacturing defects and/or repair defects, the method comprising:

providing a first substrate and a second substrate; and

intentionally producing a weakened bond between the first substrate and the second substrate, wherein the weakened bond is weaker than a reference bond, and wherein the weakened bond performs substantially similar to an accidental poor in-service bond in at least one quantitative performance test.

D2. The method of paragraph D1, further comprising providing a plurality of substrates and repeating the intentionally producing the weakened bond to produce a plurality of weakened bonds.

D3. The method of paragraph D2, further comprising determining at least one performance characteristic of each of the plurality of weakened bond.

D4. The method of paragraph D3, further comprising collecting data associated with the performance characteristics of the plurality of weakened bonds.

D5. The method of paragraph D4, further comprising storing the data associated with the performance characteristics of the plurality of weakened bonds in a computer database.

D6. The method of any of paragraphs D3-D5, further comprising developing a non-destructive test to detect poor in-service bonded joints.

D7. The method of any of paragraphs D1-D6, wherein the intentionally producing the weakened bond comprises at least one of intentionally introducing a contaminant, intentionally sanding improperly, intentionally cleaning at least one of the first substrate and the second substrate inadequately, intentionally inadequately removing moisture from at least one of the first substrate and the second substrate, intentionally using an improper conversion coating, intentionally omitting a primer, intentionally altering a primer, intentionally curing inadequately, and intentionally using an improper adhesive.

D8. The method of any of paragraphs D1-D7, further comprising creating a database of repeatable methods that may be used as a quality control check for a bonded rework associated with the repeatable methods.

D9. The method of paragraph D8, further comprising certifying a bonded rework on a primary structure of an aircraft using the database of repeatable methods.

D10. The method of any of paragraphs D1-D9, further comprising creating at least one standard to certify at least one non-destructive analysis method.

D11. The method of paragraph D10, wherein the at least one non-destructive analysis method is specific to an individual aircraft rework.

D12. The method of either of paragraphs D10 or D11, further comprising developing a new rework state decision logic to prevent in-service occurrence of weak adhesive bonds.

D13. The method of any of paragraphs D10-D12, wherein the at least one non-destructive analysis method comprises at least one of structural health monitoring, ultrasonic through transmission, pulse echo, thermography, shearography, and laser bond inspection.

D14. The method of any of paragraphs D1-D13, further comprising creating a database cataloging weak bonding interfaces and their associated lifecycle deviations.

D15. The method of paragraph D14, further comprising performing predictive analysis based on the database of weak bonding interfaces.

D16. The method of paragraph D14 or D15, further comprising developing one or more mitigation techniques using the database of weak bonding interfaces.

E1. A test standard, comprising:

first and second substrates; and

a test standard adhesive bond between the first and second substrates, wherein the test standard adhesive bond is measurably weaker than a desired strength of a reference adhesive bond.

E2. The test standard of paragraph E1, wherein the test standard comprises a plurality of first and second substrates, and a plurality of adhesive bonds between each respective pair of first and second substrates.

E3. The test standard of either of paragraphs E1 or E2, wherein the test standard adhesive bond is at least 20% weaker than the reference adhesive bond.

E4. The test standard of any of paragraphs E1-E3, wherein a measured strength of the test standard adhesive bond is measurably weaker than the desired strength of the reference adhesive bond as determined by a lap shear test.

E5. The test standard of any of paragraphs E1-E4, wherein a measured average crack length of the test standard adhesive bond is at least 50% greater than an average crack length of the reference adhesive bond, as determined by a wedge crack propagation test.

E6. The test standard of any of paragraphs E1-E5, wherein the test standard adhesive bond comprises a primer and an adhesive.

E7. The test standard of any of paragraphs E1-E6, wherein the test standard adhesive bond comprises a conversion coating mixture.

E8. The test standard of any of paragraphs E1-E7, wherein the test standard adhesive bond comprises a urethane-based primer.

E9. The test standard of any of paragraphs E1-E8, wherein the test standard adhesive bond comprises a paint primer.

E10. The test standard of any of paragraphs E1-E9, wherein the test standard adhesive bond comprises at least one of pre-bond moisture, excess moisture, an incorrect adhesive, a hydrophobic contaminant, a hydrocarbon contaminant, a mold-release agent, grease, tool grease, tape residue, silicone tape residue, and an undercured adhesive.

F1. A method of creating a test standard, comprising:

performing the method of any of paragraphs A1-D16; and

producing the test standard of any of paragraphs E1-E10.

G1. A test standard manufacturing apparatus, comprising:

an abrading apparatus;

a primer application apparatus;

a heating apparatus; and

a compaction assembly.

G2. The test standard manufacturing apparatus of paragraph G1, further comprising a conversion coating application apparatus.

G3. The test standard manufacturing apparatus of either of paragraphs G1 or G2, wherein the abrading apparatus comprises a plurality of pieces of sandpaper.

G4. The test standard manufacturing apparatus of any of paragraphs G2-G3, wherein the conversion coating application apparatus comprises a mixture of first and second conversion coating parts.

G5. The test standard manufacturing apparatus of any of paragraphs G1-G4, wherein the primer application apparatus comprises an apparatus configured to spray adhesive primer and/or paint primer onto at least one of a first substrate and a second substrate.

G6. The test standard manufacturing apparatus of any of paragraphs G1-G5, wherein the heating apparatus is configured to heat the compaction assembly to a temperature of at least 120° C.

G7. The test standard manufacturing apparatus of any of paragraphs G1-G6, wherein the compaction assembly comprises a vacuum assembly.

H1. A method for creating a plurality of altered adhesive bonds between a plurality of first substrates and a plurality of second substrates, the method comprising:

selecting a manufacturing process having a plurality of steps, wherein the manufacturing process is configured to produce a reference adhesive bond between one of the first substrates and one of the second substrates, the reference adhesive bond having a reference bond strength;

selectively altering at least one of the plurality of steps of the manufacturing process during each of a plurality of performances of the manufacturing process, thereby producing the plurality of altered adhesive bonds, each of the altered adhesive bonds being formed between one of the plurality of first substrates and one of the plurality of second substrates, wherein at least a portion of the plurality of the altered adhesive bonds have a strength that is equal to or less than an altered bond strength, wherein the altered bond strength is different from the reference bond strength; and

utilizing the plurality of altered adhesive bonds to develop a non-destructive testing method to detect an altered adhesive bond.

H2. The method of paragraph H1, further comprising comparing at least one quantitative property of each of the plurality of altered adhesive bonds with the at least one quantitative property of the reference adhesive bond.

H3. The method of paragraph H1 or H2, wherein the plurality of steps of the manufacturing process includes:
(i) selection of a selected first substrate from among the plurality of first substrates,
(ii) selection of a selected second substrate from among the plurality of second substrates,
(iii) preparation of a surface of at least one of the selected first substrate and the selected second substrate,
(iv) abrasion of at least one of the selected first substrate and the selected second substrate,
(v) application of an adhesive primer to at least one of the selected first substrate and the selected second substrate,
(vi) application of an adhesive to at least one of the selected first substrate and the selected second substrate, and
(vii) application of heat to the selected first substrate and the selected second substrate together in a vacuum to cure the adhesive.

H4. The method of any of paragraphs H1-H3, wherein the selectively altering at least one of the plurality of steps of the manufacturing process comprises substituting a paint primer for the adhesive primer.

H5. The method of any of paragraphs H1-H4, wherein the manufacturing process includes application of at least a first material to a selected first substrate and/or a selected second substrate, and wherein the selectively altering at least one of the plurality of steps comprises substituting a second material for the first material, wherein the second material has at least one of a lower shear strength and a lower peel strength than the first material.

H6. The method of any of paragraphs H1-H5, wherein the selectively altering at least one of the plurality of steps of the manufacturing process comprises introducing a contaminant to at least one of a selected first substrate and a selected second substrate, wherein the introducing the contaminant comprises at least one of introducing moisture, improperly removing moisture, introducing a hydrophobic contaminant, introducing a hydrocarbon contaminant, inadequately cleaning at least one of the first substrate and the second substrate, inadequately removing a grease, inadequately removing a mold-release agent, inadequately removing a tape residue, introducing a grease, introducing a mold-release agent, introducing a tape residue, introducing a paint primer, and inadequately removing an existing paint primer.

H7. The method of any of paragraphs H1-H6, wherein the selectively altering at least one of the plurality of steps of the manufacturing process comprises lowering a surface energy of at least one of the selected first substrate and the selected second substrate.

H8. The method of any of paragraphs H1-H7, wherein the selectively altering at least one of the plurality of steps of the manufacturing process comprises at least one of: intentionally sanding improperly, intentionally introducing an improper conversion coating, intentionally altering a primer, intentionally omitting a primer, intentionally curing inadequately, and intentionally using an improper adhesive.

H9. The method of any of paragraphs H1-H8, wherein the selectively altering at least one of the plurality of steps of the manufacturing process comprises at least one of intentionally substituting a substitute primer for a specified primer specified in the manufacturing process, intentionally mixing the primer inadequately, intentionally applying the primer at a thickness of greater than 25 μm, and intentionally applying the primer at a thickness of greater than 15 μm.

H10. The method of any of paragraphs H1-H9, wherein the selectively altering at least one of the plurality of steps of the manufacturing process comprises removing an existing paint primer from at least one of: one of the plurality of first substrates and one of the plurality of second substrates, and applying a new layer of paint primer to at least one of: one of the plurality of first substrates and one of the plurality of second substrates.

H11. The method of any of paragraphs H1-H10, wherein the selectively altering at least one of the plurality of steps comprises preparing at least one of: one of the plurality of first substrates and one of the plurality of second substrates for bonding and leaving at least some of a pre-existing paint primer on at least one of: one of the plurality of first substrates and one of the plurality of second substrates, such that the pre-existing paint primer is present at a time when the adhesive is applied.

H12. The method of any of paragraphs H1-H11, further comprising:

measuring at least one quantitative property of each of the plurality of altered adhesive bonds;

storing data resulting from the measuring the at least one quantitative property of the plurality of altered adhesive bonds; and

analyzing the data resulting from the measuring the at least one quantitative property of the altered adhesive bonds.

H13. The method of paragraph H12, further comprising using the data to certify bonded rework on a primary structure of an aircraft.

H14. The method of any of paragraphs H12-H13, further comprising developing new rework state decision logics to prevent in-service occurrence of weak bonds, based on the data resulting from the measuring the at least one quantitative property of the plurality of altered adhesive bonds.

H15. The method of any of paragraphs H1-H14, wherein each of the plurality of first substrates and each of the plurality of second substrates consist of at least one of: a metallic substrate and a composite substrate.

I1. A test standard manufacturing apparatus, comprising:

an abrading apparatus comprising a plurality of sanding means;

a primer application apparatus comprising an apparatus configured to spray at least one of an adhesive primer and a paint primer onto at least one of a first substrate and a second substrate;

a compaction assembly comprising a vacuum assembly; and

a heating apparatus, wherein the heating apparatus is configured to heat the compaction assembly to a temperature of at least 120° C., and wherein the test standard manufacturing apparatus is configured to produce a test standard, the test standard comprising an adhesive bonded joint between the first substrate and the second substrate, wherein at least one of the abrading apparatus, the primer application apparatus, the compaction assembly, and the heating apparatus is configured to alter a selected step of a manufacturing process to produce an altered adhesive bonded joint between the first substrate and the second substrate.

I2. The test standard manufacturing apparatus of paragraph I2, further comprising a conversion coating application apparatus comprising a mixture of a first conversion coating part and a second conversion coating part.

J1. A test standard, comprising:

a first metallic substrate;

a second metallic substrate; and

an altered adhesive bond formed by joining the first metallic substrate and the second metallic substrate, wherein the altered adhesive bond comprises a film adhesive, a conversion coating mixture, and a urethane-based primer, and wherein the test standard adhesive bond is measurably weaker than a desired strength of a reference adhesive bond.

J2. The test standard of paragraph J1, wherein the test standard comprises a plurality of first metallic substrates, a plurality of second metallic substrates, and a plurality of altered adhesive bonds between respective first metallic substrates and second metallic substrates.

K1. A test standard, comprising:

a first composite substrate;

a second composite substrate;

an altered adhesive bond formed by joining the first composite substrate and the second composite substrate, wherein the altered adhesive bond has been intentionally produced to include at least one of:

at least 0.3% pre-bond moisture,

(ii) an undercured adhesive, and

(iii) a hydrocarbon contaminant,
and wherein the altered adhesive bond is altered with respect to at least one quantitative property relative to a reference adhesive bond.

L1. The method of one or more of paragraphs A1-A59, B1-B13, C1-C7, D1-D16, F1, and H1-H15, utilizing one or more of: the test standard of any of paragraphs E1-E10, J1-J2, or K1; and the test standard manufacturing apparatus of any of paragraphs G1-G7 or I1-I2.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A method for creating a plurality of altered adhesive bonds between a plurality of first substrates and a plurality of second substrates, the method comprising:
selecting a manufacturing process having a plurality of steps, wherein the manufacturing process is configured to produce a reference adhesive bond between one of the plurality of first substrates and one of the plurality of second substrates, the reference adhesive bond having a reference bond strength;
selectively altering at least one of the plurality of steps of the manufacturing process during each of a plurality of performances of the manufacturing process, thereby producing the plurality of altered adhesive bonds, each of the plurality of altered adhesive bonds being formed between one of the plurality of first substrates and one of the plurality of second substrates, wherein at least a portion of the plurality of altered adhesive bonds have a strength that is equal to or less than an altered bond strength, wherein the altered bond strength is different from the reference bond strength; and
utilizing the plurality of altered adhesive bonds to develop a non-destructive testing method to detect a weakened adhesive bond.

2. The method of claim 1, further comprising comparing at least one quantitative property of each of the plurality of altered adhesive bonds with the at least one quantitative property of the reference adhesive bond.

3. The method of claim 1 wherein the plurality of steps of the manufacturing process includes:
(i) selection of a selected first substrate from among the plurality of first substrates,
(ii) selection of a selected second substrate from among the plurality of second substrates,
(iii) preparation of a surface of at least one of the selected first substrate and the selected second substrate,
(iv) abrasion of at least one of the selected first substrate and the selected second substrate,
(v) application of an adhesive primer to at least one of the selected first substrate and the selected second substrate,
(vi) application of an adhesive to at least one of the selected first substrate and the selected second substrate, and
(vii) application of heat to the selected first substrate and the selected second substrate together in a vacuum to cure the adhesive.

4. The method of claim 3, wherein the selectively altering at least one of the plurality of steps of the manufacturing process comprises substituting a paint primer for the adhesive primer.

5. The method of claim 1, wherein the manufacturing process includes application of at least a first material to a selected first substrate and/or a selected second substrate, and wherein the selectively altering at least one of the plurality of steps comprises substituting a second material for the first material, wherein the second material has at least one of a lower shear strength and a lower peel strength than the first material.

6. The method of claim 1, wherein the selectively altering at least one of the plurality of steps of the manufacturing process comprises introducing a contaminant to at least one of a selected first substrate and a selected second substrate, wherein the introducing the contaminant comprises at least one of introducing moisture, improperly removing moisture, introducing a hydrophobic contaminant, introducing a hydrocarbon contaminant, inadequately cleaning at least one of the first substrate and the second substrate, inadequately removing a grease, inadequately removing a mold-release agent, inadequately removing a tape residue, introducing a grease, introducing a mold-release agent, introducing a tape-residue, introducing a paint primer, and inadequately removing an existing paint primer.

7. The method of claim 1, wherein the selectively altering at least one of the plurality of steps of the manufacturing process comprises lowering a surface energy of at least one of a selected first substrate and a selected second substrate.

8. The method of claim 1, wherein the selectively altering at least one of the plurality of steps of the manufacturing process comprises at least one of: intentionally sanding improperly, intentionally introducing an improper conversion coating, intentionally altering a primer, intentionally omitting a primer, intentionally curing inadequately, and intentionally using an improper adhesive.

9. The method of claim 1, wherein the selectively altering at least one of the plurality of steps of the manufacturing process comprises at least one of intentionally substituting a substitute primer for a specified primer specified in the manufacturing process, intentionally mixing a primer inadequately, intentionally applying the primer at a thickness of greater than 25 μm, and intentionally applying the primer at a thickness of greater than 15 μm.

10. The method of claim 1, wherein the selectively altering at least one of the plurality of steps of the manufacturing process comprises removing an existing paint primer from at least one of: one of the plurality of first substrates and one of the plurality of second substrates, and applying a new layer of a paint primer to at least one of: one of the plurality of first substrates and one of the plurality of second substrates.

11. The method of claim 1, wherein the selectively altering at least one of the plurality of steps of the manufacturing process comprises preparing at least one of: one of the plurality of first substrates and one of the plurality of second substrates for bonding and leaving at least some of a pre-existing paint primer on at least one of: one of the plurality of first substrates and one of the plurality of second substrates, such that the pre-existing paint primer is present at a time when an adhesive is applied.

12. The method of claim 1, further comprising:
measuring at least one quantitative property of each of the plurality of altered adhesive bonds;
storing data resulting from the measuring the at least one quantitative property of each of the plurality of altered adhesive bonds; and
analyzing the data resulting from the measuring the at least one quantitative property of each of the plurality of altered adhesive bonds.

13. The method of claim 12, further comprising using the data to certify bonded rework on a primary structure of an aircraft.

14. The method of claim 12, further comprising developing new rework state decision logics to prevent in-service occurrence of weak bonds, based on the data resulting from the measuring the quantitative property of each of the plurality of altered adhesive bonds.

15. The method of claim 1, wherein each of the plurality of first substrates and each of the plurality of second substrates consist of at least one of: a metallic substrate and a composite substrate.

16. A test standard manufacturing apparatus, comprising:
an abrading apparatus comprising a plurality of sanding means;
a primer application apparatus comprising an apparatus configured to spray at least one of an adhesive primer and a paint primer onto at least one of a first substrate and a second substrate;
a compaction assembly comprising a vacuum assembly; and
a heating apparatus, wherein the heating apparatus is configured to heat the compaction assembly to a temperature of at least 120° C., and wherein the test standard manufacturing apparatus is configured to produce a test standard, the test standard comprising an adhesive bonded joint between the first substrate and the second substrate, wherein at least one of the abrading apparatus, the primer application apparatus, the compaction assembly, and the heating apparatus is configured to alter a selected step of a manufacturing process to produce an altered adhesive bonded joint between the first substrate and the second substrate.

17. The test standard manufacturing apparatus of claim 16, further comprising a conversion coating application apparatus comprising a mixture of a first conversion coating part and a second conversion coating part.

18. A test standard, comprising:
a first metallic substrate;
a second metallic substrate; and
an altered adhesive bond formed by joining the first metallic substrate and the second metallic substrate, wherein the altered adhesive bond comprises a film adhesive, a conversion coating mixture, and a urethane-based primer, and wherein the altered adhesive bond is measurably weaker than a desired strength of a reference adhesive bond.

19. The test standard of claim 18, wherein the test standard comprises a plurality of first metallic substrates, a plurality of second metallic substrates, and a plurality of altered adhesive bonds between respective first metallic substrates and second metallic substrates.

20. A test standard, comprising:
a first composite substrate;
a second composite substrate;
an altered adhesive bond formed by joining the first composite substrate and the second composite substrate, wherein the altered adhesive bond has been intentionally produced to include at least one of:
(i) at least 0.3% pre-bond moisture,
(ii) an undercured adhesive, and
(iii) a hydrocarbon contaminant,
and wherein the altered adhesive bond is altered with respect to at least one quantitative property relative to a reference adhesive bond.
